(19) United States
(12) Patent Application Publication
(10) Pub. No.: US 2024/0365184 A1
(43) Pub. Date: Oct. 31, 2024

(54) First Network Node, Second Network Node, First Wireless Device, and Methods Performed Thereby for Handling Wireless Devices

(71) Applicant: Telefonaktiebolaget LM Ericsson (publ), Stockholm (SE)

(72) Inventors: Mattias Bergström, Sollentuna (SE); Tuomas Tirronen, Helsinki (FI); Mohammed Yazid Lyazidi, London (GB)

(21) Appl. No.: 18/290,216

(22) PCT Filed: May 17, 2022
(86) PCT No.: PCT/SE2022/050478

§ 371 Date: Nov. 10, 2023

Related U.S. Application Data
(60) Provisional application No. 63/190,350, filed on May 19, 2021.

(51) Int. Cl. H04W 36/00

(52) U.S. Cl. CPC H04W 36/0077; H04W 36/0069; H04W 36/0085

(57) ABSTRACT

A performed by a first node (111). The method is for handling wireless devices (130). The first node (111) operates in a communications network (100). The first node (111) determines (202) whether or not a second network node (112) comprised in the communications network (100) accepts to serve wireless devices (130) of a first type. The first node (111) then performs (203) a first action based on a result of the determination. In a method performed by the second network node (112), the second network node (112) sends (301) an indication to the first network node (111). The indication indicates whether or not the second network node (112) accepts to serve the wireless devices (130) of the first type. A first wireless device (131) operating in a communications network (100), sends (401) the indication to the first network node (111). The indication indicates whether the second network node (112) accepts to serve the wireless devices (130).

### TECHNICAL FIELD

The present disclosure relates generally to a first network node, and methods performed thereby, for handling wireless devices. The present disclosure also relates generally to a second network node and methods performed thereby for handling the wireless devices. The present disclosure further relates generally to a first wireless device and methods performed thereby.

### BACKGROUND

Wireless devices within a wireless communications network may be e.g., User Equipments (UEs), stations (STAs), mobile terminals, wireless terminals, terminals, and/or Mobile Stations (MS). Wireless devices may be enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations may communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network, which may be referred to as Next Generation (NG) Core Network, abbreviated as NG-CN, NGC or 5G CN.

### Internet of Things (IoT)

The Internet of Things (IoT) may be understood as an internetworking of communication devices, e.g., physical devices, vehicles, which may also be referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

### Reduced Capability NR Devices

5G is the fifth generation of cellular technology and was introduced in Release 15 of the 3GPP standard. It is designed to increase speed, reduce latency, and improve flexibility of wireless services. The 5G system (5GS) may include both a new radio access network (NG-RAN) which makes use of a new air interface called New Radio (NR), and a new core network (5GC).

The initial release of 5G in Release 15 may be understood to be optimized for mobile broadband (MBB) and ultra-reliable and low latency communication (URLLC). These services may be understood to require very high data rates and/or low latency and therefore may put high requirements on a User Equipment (UE). To enable 5G to be used for other services with more relaxed performance requirements, a new low complexity UE type is introduced in Release 17, called ‘reduced capability NR devices’ or RedCap. The low complexity UE type may be understood to be particularly suited for machine type communication (MTC) services, such as wireless sensors or video surveillance, but it may also be used for MBB services with lower performance requirements, such as wearables. The low complexity UE may be understood to have reduced capabilities compared to a Release 15 NR UE. For full details, reference may be made to the Rel-17 work item description in RP-210918, which may be understood to have as objective to specify support for the following UE complexity reduction features, in RAN1, RAN2, RAN4. First, reduced maximum UE bandwidth. Maximum bandwidth of a Frequency 1 (FR1) RedCap UE during and after initial access may be 20 Megahertz (MHz). Maximum bandwidth of a Frequency 2 (FR2) RedCap UE during and after initial access may be 100 MHz Second, reduced minimum number of Receive (Rx) branches. For frequency bands where a legacy NR UE may be required to be equipped with a minimum of 2 Rx antenna ports, the minimum number of Rx branches supported by specification for a RedCap UE may be 1. The specification may also support 2 Rx branches for a RedCap UE in these bands. For frequency bands where a legacy NR UE, other than 2-Rx vehicular UE, may be required to be equipped with a minimum of 4 Rx antenna ports, the minimum number of Rx branches supported by specification for a RedCap UE may be 1. The specification may also support 2 Rx branches for a RedCap UE in these bands. A means may be specified by which the gNB may know the number of Rx branches of the UE. Third, maximum number of DL Multiple Input Multiple Output (MIMO) layers. For a RedCap UE with 1 Rx branch, 1 DL MIMO layer may be supported. For a RedCap UE with 2 Rx branches, 2 DL MIMO layers may be supported. Fourth, relaxed maximum modulation order. Support of 256 Quadrature amplitude modulation (QAM) in DL may be optional, instead of mandatory, for an FR1 RedCap UE. No other relaxations of maximum modulation order have been specified for a RedCap UE. Fifth, duplex operation. Half-Duplex Frequency Division Duplex (HD-FDD) type A with the minimum specification impact. It may be noted that Full-Duplex Frequency Division Duplex (FD-FDD) and Time Division Duplex (TDD) may be also supported.

Because of the reduced capabilities, the low complexity UE may sometimes also be referred to as an NR RedCap UE. An NR RedCap UE may have some or all of the reduced capabilities above.

A likely outcome of the ongoing work item may be that a RedCap UE may be defined by the support of: maximum UE bandwidth of 20 MHz, in FR1, or 100 MHz, in FR2, possible support of only one MIMO layer and number of Rx antenna branches, support for 64QAM in downlink, 256QAM may be optional, and HD-FDD operation within one carrier.

### Use Cases

RedCap UEs may consume more resources compared to regular UEs. For example, due to that they may have limited capabilities, such as lower maximum bandwidth, RedCap UEs may require repetitions of certain messages, signals, etc. It has therefore been agreed to introduce an indication, which the network may send in system information, which may indicate if the cell accepts that RedCap UEs connect to a cell. If a RedCap UE sees that a cell indicates that it does not accept RedCap UEs, the RedCap UE may be configured to not attempt to connect to the cell. The indication may be specific to certain RedCap UE features such as support of 1 Rx or 2 Rx branches.

The system information indication is mentioned in the Rel-17 work item description in RP-210918 as another objective to specify a system information indication to indicate whether a RedCap UE may camp on the cell/frequency or not; it may be possible for the indication to be specific to the number of Rx branches of the UE.

Existing methods to handle wireless devices with reduced capabilities, such as RedCap UEs my result in create unnecessary and unwanted signaling as well as wasted radio resources and UE energy.

### SUMMARY

As part of the development of embodiments herein, one or more challenges with the existing technology will first be identified and discussed.

As described above, a node, or cell of a node, may not accept serving RedCap UEs. The reason may be that the RedCap UEs may consume too many network resources. However, even if the indication in system information mentioned above is introduced, another network node, e.g., a first network node may attempt to handover a RedCap UE to the above-named node, e.g., a second node. In the worst case, the second node may then serve the RedCap UE that was handed over to it. But it may be so that the second node may be able to determine that the incoming UE is a RedCap UE and then reject the handover. However, to have attempted this handover may be understood to create unnecessary and unwanted signaling between the network nodes over the Xn interface, and the UE may have performed measurements preceding the handover in vain, which wasted radio resources and UE energy.

As noted in R2-2104775, in the current specification, a cell does not advertise to its neighbours whether it supports RedCap or not. This may have negative implication on handover and cell reselection procedures. For example, when a source cell may be about to handover a RedCap UE to a target cell, it may not know whether the target cell supports or is currently barring RedCap UEs until it gets a reject message from the target cell. When that happens, the source cell may have to try the next target cell in its list. But rejection may happen again, for the same aforementioned reason. This clearly is very inefficient for the gNB and may increase the handover latency and chance of handover failure of the UE.

This issue may not be avoided by network planning, because cell barring for RedCap may be more dynamic than non-RedCap UEs, as it may depend more on a cell's loading. It has been advertised that knowing whether a neighbour cell accepts access by Redcap or not may help a gNB ensure not to handover a RedCap UE to a target cell that it cannot access.

Once a gNB may know which neighbour cells do not support or may be currently barring RedCap, it may configure RedCap UEs in RRC Connected to avoid performing Radio Resource Management (RRM) measurements on those neighbour cells. In addition, it may advertise that information in its system information, e.g., in System Information Block (SIB) 3 & 4, so that RedCap UEs in Radio Resource Control (RRC) Idle/Inactive may avoid performing RRC measurements on those neighbour cells.

A solution may thus be needed to allow exchange of information between gNBs on whether they support or may be currently barring RedCap UEs. The detailed signalling solution has not been studied, nor disclosed yet.

According to the foregoing, it is an object of embodiments herein to improve the handling of wireless devices in a communications network.

According to a first aspect of embodiments herein, the object is achieved by a method, performed by a first network node. The method is for handling wireless devices. The first network node operates in the communications network. The first network node determines whether or not a second network node comprised in the communications network accepts to serve wireless devices of a first type. The first network node then performs a first action based on a result of the determination.

According to a second aspect of embodiments herein, the object is achieved by a method, performed by the second network node. The method is for handling the wireless devices. The second node operates in the communications network. The second network node sends an indication to the first network node comprised in the communications network. The indication indicates whether or not the second network node accepts to serve wireless devices of the first type.

According to a third aspect of embodiments herein, the object is achieved by a method, performed by a first wireless device. The first wireless device operates in the communications network. The first wireless device sends the indication to the first network node operating in the communications network. The indication indicates whether or not the second network node accepts to serve the wireless devices of the first type.

According to a fourth aspect of embodiments herein, the object is achieved by the first network node, for handling the wireless devices. The first network node is configured to operate in the communications network. The first network node is further configured to determine whether or not the second network node configured to be comprised in the communications network accepts to serve the wireless devices of the first type. The first network node is also configured to perform the first action based on the result of the determination.

According to a fifth aspect of embodiments herein, the object is achieved by the second network node, for handling the wireless devices. The second network node is configured to operate in the communications network. The second network node is further configured to send the indication to the first network node configured to be comprised in the communications network. The indication is configured to indicate whether or not the second network node accepts to serve the wireless devices of the first type.

According to a sixth aspect of embodiments herein, the object is achieved by the first wireless device. The first wireless device is configured to operate in the communications network. The first wireless device is further configured to send the indication to the first network node configured to operate in the communications network. The indication is configured to indicate whether or not the second network node accepts to serve the wireless devices of the first type.

By the first network node determining whether or not the second network node accepts to serve the wireless devices of the first type, e.g., which may be limited in one or more features, such as RedCap UEs, the first network node may then perform the first action accordingly. For example, the first network node may therefore be enabled to apply restriction rules for mobility accordingly. Accordingly, the first network node may be enabled to ensure that unnecessary handovers are not attempted for wireless devices of the first type, e.g., RedCap UEs, to nodes which do not accept wireless devices of the first type, e.g., RedCap UEs. In others example, measurements, e.g., RRM measurements, may be enabled to be avoided by wireless devices of the first type, e.g., RedCap UEs. This may be since the first network node may avoid reconfiguring such wireless devices, e.g., the first wireless device, when preparing for the handover procedure, which may save energy for both the first wireless device, e.g., a UE, and the network.

By the second network node sending the indication, the second network node may enable the first network node to perform the determination and act accordingly.

By the first wireless device sending the indication, which it may have obtained from the second network node, the first wireless device may enable the first network node to perform the determination and act accordingly.

### BRIEF DESCRIPTION OF THE DRAWINGS

Examples of embodiments herein are described in more detail with reference to the accompanying drawings, and according to the following description.

FIG. 1 is a schematic diagram illustrating a communications network, according to embodiments herein.

FIG. 2 is a flowchart depicting an example of a method in a first network node, according to embodiments herein.

FIG. 3 is a flowchart depicting an example of a method in a second network node, according to embodiments herein.

FIG. 4 is a flowchart depicting an example of a method in a first wireless device, according to embodiments herein.

FIG. 5 is a schematic representation depicting a non-limiting example of methods according to embodiments herein.

FIG. 6 is a schematic block diagram illustrating two non-limiting examples, a) and b), of a first network node, according to embodiments herein.

FIG. 7 is a schematic block diagram illustrating two non-limiting examples, a) and b), of a second network node, according to embodiments herein.

FIG. 8 is a schematic block diagram illustrating two non-limiting examples, a) and b), of a first wireless device, according to embodiments herein.

FIG. 9 is a flowchart depicting an example of a method in the first network node, related to embodiments herein.

FIG. 10 is a flowchart depicting an example of a method in the second network node, related to embodiments herein.

FIG. 11 is a flowchart depicting an example of a method in the first wireless device, related to embodiments herein.

FIG. 12 is a schematic block diagram illustrating a telecommunication network connected via an intermediate network to a host computer, according to embodiments herein.

FIG. 13 is a generalized block diagram of a host computer communicating via a base station with a user equipment over a partially wireless connection, according to embodiments herein.

FIG. 14 is a flowchart depicting embodiments of a method in a communications system including a host computer, a base station and a user equipment, according to embodiments herein.

FIG. 15 is a flowchart depicting embodiments of a method in a communications system including a host computer, a base station and a user equipment, according to embodiments herein.

FIG. 16 is a flowchart depicting embodiments of a method in a communications system including a host computer, a base station and a user equipment, according to embodiments herein.

FIG. 17 is a flowchart depicting embodiments of a method in a communications system including a host computer, a base station and a user equipment, according to embodiments herein.

### DETAILED DESCRIPTION

Certain aspects of the present disclosure and their embodiments may provide solutions to this challenge or other challenges. There are, proposed herein, various embodiments which address one or more of the issues disclosed herein.

Embodiments herein may be understood to related to handling of Redcap UE acceptance during inter-node mobility.

Particular embodiments herein may be understood to be related to methods based on cell-specific and UE-specific signalling solutions to enable inter-gNBs to acquire knowledge on RedCap UE acceptance, and to apply restriction rules for mobility accordingly.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

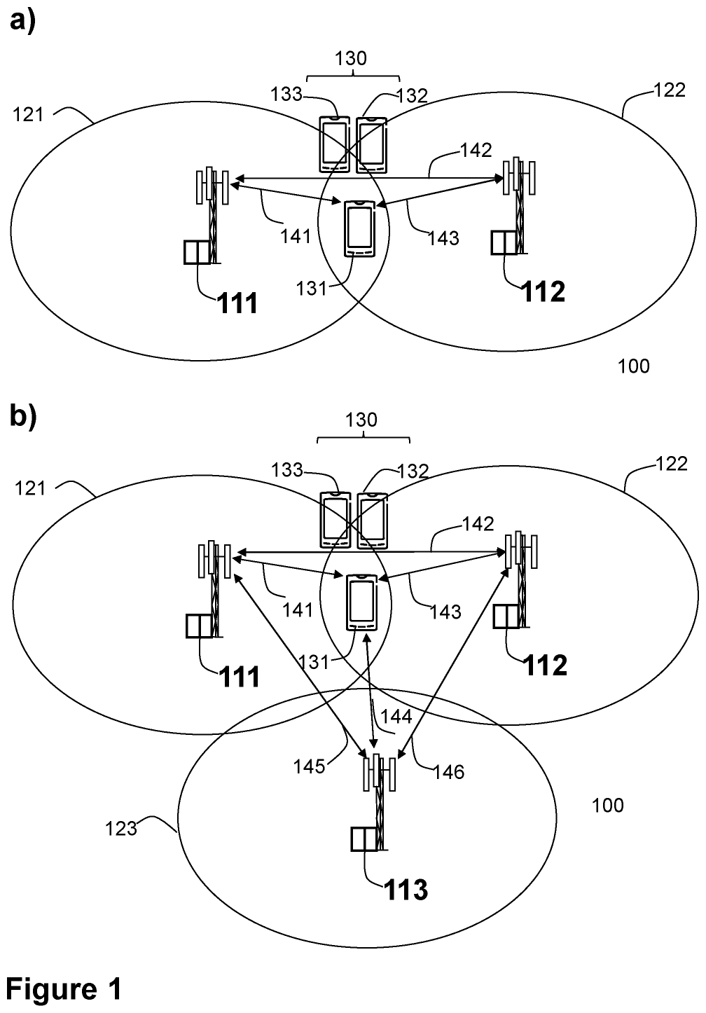

FIG. 1 depicts two non-limiting examples in panel a) and panel b), respectively, of a communications network 100, sometimes also referred to as a wireless communications network, wireless communications system, cellular radio system, or cellular network, in which embodiments herein may be implemented. The communications network 100 may typically be a 5G system, 5G network, NR-U or Next Gen System or network, LAA, MulteFire. The communications network 100 may support a younger system than a 5G system. The communications network 100 may support other technologies, such as, for example Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, etc. . . . Other examples of other technologies the communications network 100 may support may be Wideband Code Division Multiple Access (WCDMA), Universal Terrestrial Radio Access (UTRA) TDD, GSM network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, NarrowBand IoT (NB-IoT), IEEE 802.15.4-based low-power short-range networks such as IPv6 over Low-Power Wireless Personal Area Networks (6LowPAN), Zigbee, Z-Wave, Bluetooth Low Energy (BLE), Machine to Machine (M2M), or any cellular network or system. Thus, although terminology from 5G/NR and LTE may be used in this disclosure to exemplify embodiments herein, this should not be seen as limiting the scope of the embodiments herein to only the aforementioned systems.

The communications network 100 comprises a plurality of nodes, whereof a first network node 111 and a second network node 112 are depicted in the non-limiting example of panel a) and panel b) in FIG. 1. In some embodiments, the communications network 100 may further comprise other nodes, whereof a another network node 113, which may be understood to be a third network node, is also depicted in the non-limiting example of panel b) in FIG. 1. Any of the first network node 111, the second network node 112 and the third network node 113 may be a radio network node, wherein the first network node 111 may be a first radio network node, the second network node 112 may be a second radio network node, and the third network node 113 may be a third radio network node. That is, any of the first network node 111, the second network node 112 and the third network node 113 may be a transmission point such as a radio base station, for example a gNB, an eNB, or any other network node with similar features capable of serving a wireless device, such as a user equipment or a machine type communication device, in the communications network 100. In other examples, which are not depicted in FIG. 1, any of the first network node 111, the second network node 112 and the third network node 113 may be a distributed node, such as a virtual node in the cloud, and may perform its functions entirely on the cloud, or partially, in collaboration with a radio network node. In some examples, the first network node 111 may be also referred to herein as a source node, and the second network node 112 may be referred to herein as a target node, based on context. In other examples, the first network node 111 may be also referred to herein as a target node, and the second network node 112 may be referred to herein as a source node, based on context.

The communications network 100 covers a geographical area which may be divided into cell areas, wherein each cell area may be served by a network node, although, one radio network node may serve one or several cells. The communications network 100 may comprise a first cell 121, which may be also referred to herein as a source cell. In some embodiments, the communications network 100 may also comprise a second cell 122, which may be also referred to herein as a target cell. In some embodiments, the communications network 100 may further comprise a third cell 123, which may be also referred to herein as another target cell.

Any of the first network node 111, the second network node 112 and the third network node 113 may be of different classes, such as, e.g., macro base station, home base station or pico base station, based on transmission power and thereby also cell size.

In some examples, which are not depicted in FIG. 1, the second network node 112 may be a core network node in the communications network 100. In some of such embodiments, the first network node 111 may be a first radio network node.

Any of the first network node 111, the second network node 112 and the third network node 113 may support one or several communication technologies, and its name may depend on the technology and terminology used. In 5G/NR, any of the first network node 111 and the second network node 112 may be referred to as a gNB and may be directly connected to one or more core networks.

A plurality of wireless devices 130 may be comprised in the wireless communication network 100, whereof a first wireless device 131, is depicted in the non-limiting examples of FIG. 1. The wireless devices 130 may further comprise another wireless device 132, which may be also referred to herein as a second wireless device 132. Any reference herein to a/the wireless device 131, 132 may be understood to apply to any of the first wireless device 131 and the second wireless device 132. In some embodiments, the wireless devices 130 may comprise a further wireless device 133, which may also be referred to herein as a third wireless device 133. Any of the wireless devices 130 comprised in the communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the wireless devices 130 comprised in the communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. Any of the wireless devices 130 comprised in the communications network 100 is enabled to communicate wirelessly in the communications network 100. The communication may be performed e.g., via a RAN, and possibly the one or more core networks, which may be comprised within the communications network 100.

Any of the wireless devices 130 may be, in particular embodiments, a RedCap UE.

The first wireless device 131 may be configured to communicate within the communications network 100 with the first network node 111 in the first cell 121 over a first link 141, e.g., a radio link. The first network node 111 and the second network node 112 may be configured to communicate within the communications network 100 over a second link 142, e.g., a wired link, a radio link or an X2 interface. The first wireless device 131 may be configured to communicate within the communications network 100 with the second network node 112 in the second cell 122 over a third link 143, e.g., a radio link. The first wireless device 131 may be configured to communicate within the communications network 100 with the third network node 113 in the third cell 123 over a fourth link 144, e.g., a radio link. The first network node 111 and the third network node 113 may be configured to communicate within the communications network 100 over a fifth link 145, e.g., a wired link, a radio link or an X2 interface. The second network node 112 and the third network node 113 may be configured to communicate within the communications network 100 over a sixth link 146, e.g., a wired link, a radio link or an X2 interface.

Similar links may be understood to apply to the second wireless device 132 and/or the further wireless device 133. These links are not depicted in FIG. 1 to avoid overcrowding the figure.

In general, the usage of “first”, “second”, “third”, “fourth”, “fifth” and/or “sixth” herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a first network node, such as the first network node 111, e.g., a gNB-CU, embodiments related to a second network node, such as the second network node 112, e.g., another gNB-CU or a core network node, and embodiments related to a wireless device, such as the first wireless device 131, e.g., a UE.

Some embodiments herein will be further described with some non-limiting examples. In the following description, any reference to a/the first node, and/or the first network node, and/or the first base station, and/or a/the “NR gNB” and/or “another base station”, may be understood to equally refer to any of the first network node 111; any reference to a/the second node, a/the second network node may be understood to equally refer to the second network node 112; any reference to a/the UE and/or the RedCap UE may be understood to equally refer to any of the first wireless device 131 and the another wireless device 132; any reference to RedCap UEs may be understood to equally refer the wireless devices 130 of the first type.

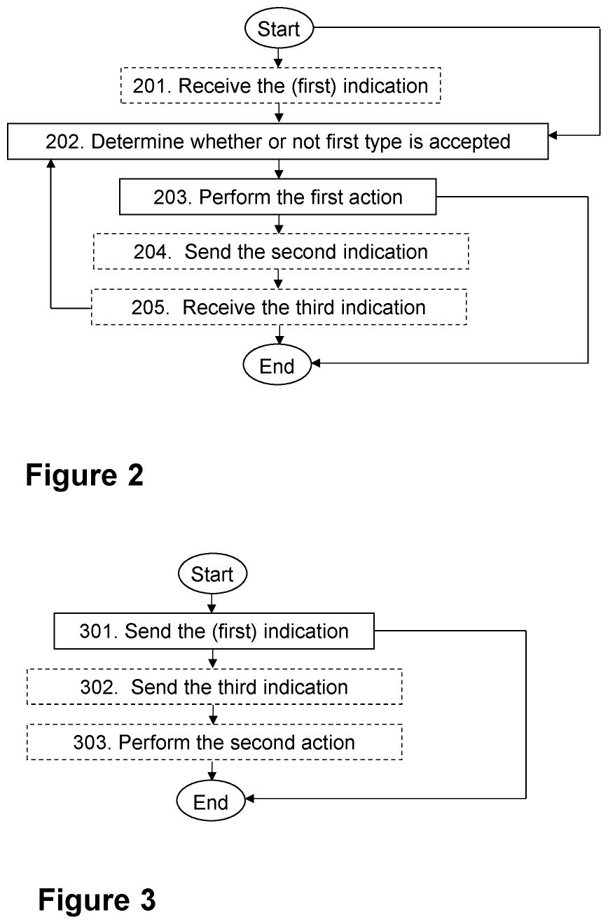

Embodiments of a method performed by a first network node, such as the first network node 111, will now be described with reference to the flowchart depicted in FIG. 2. The method may be understood to be for handling wireless devices, such as the wireless devices 130. The first network node 111 operates in the communications network 100.

Several embodiments are comprised herein. In some embodiments all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first network node 111 is depicted in FIG. 2. Examples of these actions and the indications which will be described are provided in this document. Some actions may be performed in a different order than that shown FIG. 2.

In FIG. 2, actions which may be optional in some examples are depicted with dashed boxes.

### Action 201

According to embodiments herein, the second network node 112 may indicate to the a first network node 111 whether the second network node 112 accepts to serve UEs of a certain type. For example, a second base station such as an NR gNB may indicate to another base station whether the second base station accepts to serve UEs of RedCap type.

In this Action 201, the first network node 111 may receive an indication from one of the second network node 112, e.g., via the second link 142, and the first wireless device 131, e.g., via the first link 141. The indication may indicate whether or not the second network node 112 may accept to serve the wireless devices 130 of a first type. The wireless devices 130 of the first type may be limited in one or more features with respect to wireless devices 130 of a second type. In some embodiments, the wireless devices 130 of the first type may be RedCap UEs. It may be noted that, as in FIG. 5, it may be used as examples that the second network node 112 may indicate to the first network node 111 whether it accepts RedCap UEs, however, embodiments herein may be applied for other types of UEs as well.

Below, a “RedCap UE” or “RedCap type” may be understood to refer to a UE which may have some of the characteristics listed in the background and mentioned in the WID, e.g., supporting narrower Bandwidth (BW) compared to Rel-15 NR UEs, or supporting only one MIMO layer or Rx branch, or supporting only 64 QAM instead of 256 QAM in downlink, or supporting HD-FDD operation within a single carrier. The “RedCap UE” or “RedCap type” may be indicated by the UE during initial access e.g., through a random access preamble or in signaling from UE to gNB, or via an explicit UE capability in UE-NR-Capability. The “RedCap UE” or “RedCap type” may be defined in a specification.

It is described that the indication may indicate whether the second network node 112 “accepts” the wireless devices 130 of the first type, e.g., RedCap UEs or not. However, it may be that the indication may indicate whether the second network node 112 may “support” the wireless devices 130 of the first type, e.g., RedCap UEs or not. Other semantics for the indication may also be possible, however, for the sake of readability, the indication will be referred to herein as an indication of whether the second network node “accepts” the wireless devices 130 of the first type, e.g., RedCap UEs or not.

In some embodiments, the indication may further indicate the one or more cells where the wireless devices 130 of the first type may be able to be served or not served.

So far, it has been described that the indication may indicate whether the second network node 112, as a whole, accepts or not accept the wireless devices 130 of the first type, e.g., RedCap UEs. However, the indication may be more granular. For example, there may be an indication per cell, frequency, tracking area code, Public Land Mobile Network (PLMN) Identity or Identifier (ID), Radio Access Technology (RAT) type, etc. of the second network node 112. The indication may be further divided based on the specific features the wireless devices 130 of the first type, e.g., RedCap UE, may support, for example, a different indication may be provided depending on whether the UE may support 1 Rx branch or antenna port or 2 Rx branches or antenna ports.

According to the foregoing, in some embodiments, at least one of the following may apply: i) the indication may be specific to one or more of: a cell, a frequency, a tracking area code, a Public Land Mobile Network (PLMN), and a type of Radio Access Technology (RAT), and ii) the indication may be based on one or more features supported by the first wireless device 131 of the first type.

### How the First Network Node 111 May Acquire the Indication

### a) From the Second Network Node 112

In some embodiments, the first network node 111 may be a first radio access network node, and the second network node 112 may be a second radio access network node. In some of such embodiments, the receiving in this Action 201 of the indication may be performed according to at least one of the following options.

According to a first option, the receiving in this Action 201 of the indication may be performed i) in an interface between the second network node 112 and the first network node 111. The indication may be sent from the second network node 112 to the first network node 111 on the interface which may connect the first network node 111 and second network node 112, such as the Xn interface.

According to a second option, the receiving in this Action 201 of the indication may be performed ii) when the interface may be set up. The indication may be signaled on a message sent when the interface may be setup, e.g., when the Xn-interface may be set up. This may ensure that the indication may be available at the first network node 111 from the beginning.

According to a third option, the receiving in this Action 201 of the indication may be performed iii) in a message received after the interface may have been set up. The indication may be provided in a message which the second network node 112 may send after the interface may have been established. This may allow the second network node 112 to change the value of the indication if the second network node 112 may e.g., no longer accept wireless devices 130 of the first type, e.g., RedCap UEs, or if it may start to accept RedCap UEs.

In another example, a node not accepting wireless devices 130 of the first type, e.g., NR Redcap UE may progressively transmit this restriction information to other nodes in the same network. According to a fourth option, the receiving in this Action 201 of the indication may be performed iv) in one of a Served Cell Information NR IE or a Neighbour Information NR IE. As a non-limiting example, during the Xn Setup and/or Configuration Update procedures, the second network node 112 may inform the first network node 111 about its non-acceptance of RedCap UEs during the response messages of the abovementioned Xn procedures. The second network node 112 may, for instance, add an indication in the Served Cell Information NR Information Element (IE) or Neighbour Information NR IE about its served cells that will/may not serve RedCap UEs. The indication may indicate the cells where wireless devices 130 of the first type, e.g., RedCap UEs, may be served or not served.

According to a fifth option, the receiving in this Action 201 of the indication may be performed v) in a response to a request from the first network node 111. The indication may be sent in a request-response message. For example, the first network node 111 may request the second network node 112 to send the indication upon which the second network node 112 may send the indication.

According to a sixth option, the receiving in this Action 201 of the indication may be performed vi) with the proviso that the first network node 111 may support wireless devices 130 of the first type. The second network node 112 may only send the indication to the first network node 111 if the second network node 112 determines that the first network node 111 supports wireless devices 130 of the first type, e.g., RedCap.

In an embodiment, the above may be done proprietarily without standardization effort.

According to a seventh option, the receiving in this Action 201 of the indication may be performed vii) in a handover request message.

According to an eighth option, the receiving in this Action 201 of the indication may be performed viii) in a response to a message retrieving a UE context. In an example of embodiments herein, when preparing a handover request to the second network node 112, due to the first wireless device 131, e.g., a UE, performing mobility action within the same operating network, the first network node 111 may add a first type restriction, e.g., RedCap restriction, information explicitly in the HANDOVER REQUEST and RETRIEVE UE CONTEXT RESPONSE messages to the second network node 112, to prevent the first wireless device 131, e.g., RedCap UE, from being configured by the second RAN node.

According to a ninth option, the receiving in this Action 201 of the indication may be performed ix) in a handover procedure, e.g., wherein the first network node 111 may be a target node; e.g., in a Mobility Restriction List IE, RAT Restriction Information IE, a HANDOVER REQUEST FAILURE, HANDOVER REQUEST ACKNOWLEDGE, and.

In another example of embodiments herein, when a wireless device of the first type, e.g., RedCap UE is in RRC_CONNECTED state and may perform mobility action towards a new RAN node, e.g., the second network node 112 described above, the source RAN node, that is, the first RAN node, e.g., the first network node 111, while triggering the handover procedure towards the target RAN node, may include the wireless devices 130 of the first type, e.g., RedCap, restriction in the Handover Restriction List. In a non-limiting example, a new RedCap explicit indicator may be added in the Mobility Restriction List IE of TS 38.423, v. 16.5.0. In yet another example of embodiments herein, the wireless devices 130 of the first type, e.g., RedCap, restriction may take the form of a specific RAT type restriction and added to the RAT Restriction Information IE in TS 38.423, v. 16.5.0. In another example of embodiments herein, the restriction may apply based on the wireless devices 130 of the first type, e.g., “RedCap UE” or “RedCap type”, definition, or any other term that may be defined in the XnAP specification that may refer to RedCap UEs. In another example of embodiments herein, when the second network node 112, e.g., the second RAN node may receive the wireless devices 130 of the first type, e.g., RedCap, UE restriction information, it may either send a HANDOVER REQUEST FAILURE message to the first network node 111, e.g., first RAN node. Alternatively, the second network node 112, e.g., the second RAN node may send a HANDOVER REQUEST ACKNOWLEDGE message and apply access restriction to the first wireless device 131, e.g., UE, for certain services.

According to a tenth option, x) during a dual connectivity procedure. The above examples may be valid for dual connectivity (DC) networks, where, for instance, a Master node may communicate to its secondary node(s), during DC connectivity related procedures, the wireless devices 130 of the first type, e.g., RedCap UE, restriction indication.

### b) From CN

The RedCap restriction may be signalled between Core Network (CN) and a RAN node, e.g., first or second RAN node. That is, between first network node 111 and second network node 112. The CN may know, during initial access by the first wireless device 131, e.g., initial UE access, that the first wireless device 131 is a wireless device of the first type, e.g., that the UE is a RedCap type, and send an indication to restrict wireless devices 130 of the first type, e.g., RedCap UE, access/roaming to other network nodes. For instance, the Application Managing Function (AMF) may send the RedCap restriction to the RAN node, as a new explicit IE in DL Non-Access Stratum (NAS) TRANSPORT or in the INITIAL CONTEXT SETUP REQUEST messages, or a general restriction indication, or included in the Mobility Restriction List IE as specified in TS 38.413, v. 16.5.0. The CN may also send a restriction for wireless devices 130 of the first type, e.g., RedCap UEs, when it may receive a PATH SWITCH REQUEST from a new node, after a successful Xn-based handover.

In one example of embodiments herein, the RAN node may notify the CN node, e.g., AMF, over NG interface that the first wireless device 131, e.g., a UE, is of the first type, e.g., a RedCap type. The AMF may store the information in the UE context and may send it to other network nodes for mobility restriction purposes.

In another example, the restriction may apply based on the wireless device of the first type, e.g., “RedCap UE” or “RedCap type”, definition, or any other term that may be defined in the NGAP specification that refers to RedCap UEs.

In accordance with the foregoing, in some embodiments, the first network node 111 may be a radio access network node and the second network node 112 may be a core network node. In some of such embodiments, the receiving in this Action 201 of the indication may be performed according to at least one of: i) in an IE in a DL Non-access Stratum (NAS) TRANSPORT message, ii) in an INITIAL CONTEXT SETUP REQUEST message, iii) in a general message, iv) in a Mobility Restriction List IE, and v) according to an NG Application Protocol (NGAP) specification.

### c) From UE

In one example of embodiments herein, the first network node 111 may receive from a UE such as the first wireless device 131, information indicating whether the second network node 112 accepts wireless devices 130 of the first type, e.g., RedCap UEs, or not. As described in the background, a serving cell may indicate in system information if the cell accepts wireless devices 130 of the first type, e.g., RedCap UEs, or not, or a wireless device 130 of the first type, e.g., a RedCap UE, supporting certain feature such as 1 Rx branch or 2 Rx branches. The first wireless device 131, e.g., UE, may, according to this example, therefore acquire the information regarding the second cell 122's acceptance of wireless devices 130 of the first type, e.g., RedCap UEs, from system information for the second cell 122 and send it to the first cell 121.

The first wireless device 131, e.g., UE, may be requested by the first network node 111 to perform such reporting. One approach may be that the first wireless device 131, e.g., UE, may report the System Information Broadcast (SIB) of the second network node 112, at least the SIB which may contain the indication of whether the cell accepts system information.

In some embodiments, the second network node 112 may be a second radio access network node, and the receiving by the first wireless device 131 of the indication may be performed in system information.

### Encoding of the Indication

In some embodiments, the indication may indicate whether or not the second network node 112 accepts to serve wireless devices 130 of the first type by one of: i) its presence, and ii) a value of the indication. The indication may be a bit which if set to a first value may indicate that the second network node 112 accepts wireless devices 130 of the first type, e.g., RedCap UEs, and if set to a second value may indicate that the second network node 112 does not accept wireless devices 130 of the first type, e.g., RedCap UEs.

Another approach may be that the indication has absence/presence logic. For example, if the indication is present, or absent, it may indicate that the second network node 112 does accept wireless devices 130 of the first type, e.g., RedCap UEs, but if the indication is absent, or present, it may indicate that the second network node 112 does not accept wireless devices 130 of the first type, e.g., RedCap UEs.

In some embodiments, at least one of the following may apply: i) the indication may be updatable, and ii) one or more conditions, to which the indication may be subject may be updatable. The one or more conditions may comprise, for example, cells where the wireless devices 130 of the first type may be accepted. Herein reference may be made to one or more first, second, third and fourth conditions. This may be understood to indicate that the one or more conditions may not be necessarily the same. They may be different or the same. In this particular action 201, the one or more conditions may be referred to herein as one or more “third conditions”.

By receiving the indication from the second network node 112 in this Action 201, the first network node 111 may be enabled to know that the second network node 112 may advertise to its neighbours whether it supports wireless devices 130 of the first type, e.g., RedCap, or not. This may be advantageous for handover and cell reselection procedures. For example, if the first network node 111 may want to handover a wireless device of the first type, e.g., RedCap UE, to the second cell 122 served by second network node 112, it may be enabled to know whether the second cell 122 supports or is currently barring wireless devices 130 of the first type, without needing to wait to get a reject message from the second cell 122. The first network node 111 may be therefore enabled to ensure not to handover a wireless device of the first type to a target cell that the wireless devices of the first type may not be allowed to access. Hence, the first network node 111 may be enabled to perform handover procedures more efficiently and may be enabled to reduce a latency of the handover of the wireless devices 130 of the first type as well as the chance of handover failure.

### Action 202

In this Action 202, the first network node 111 may determine whether or not the second network node 112 comprised in the communications network 100 accepts to serve wireless devices 130 of the first type.

Determining may be understood as e.g., calculating or deciding.

The determining of Action 202 may be based on the received indication.

In some embodiments, the determining in this Action 202 may be based on whether or not the first network node 111 may receive the indication, also referred to herein as the first indication, from the one of the second network node 112 and the first wireless device 131 comprised in the communications network 100. As stated earlier, the indication may indicate whether or not the second network node 112 accepts to serve wireless devices 130 of the first type. In particular embodiments, the determining in this Action 202 may be based on the received indication.

### Action 203

When the first network node 111 may have determined whether the second network node 112 accepts wireless devices 130 of the first type, e.g., RedCap UEs, the first network node 111 may take certain actions, as described in this Action 203. The actions taken by the first network node 111 may be based on the received indication.

In this Action 203, the first network node 111 performs an action, e.g., a first action The performing of the first action may be based on a result of the determination performed in Action 202.

In some embodiments, the first action may be at least one of: i) refrain from handing over a wireless device 131, 132 of the first type e.g., the first wireless device 131 or the another wireless device 132, to the second network node 112, e.g., based on one or more first conditions, ii) hand over the wireless device 131, 132 of the first type e.g., the first wireless device 131 or the another wireless device 132, to the second network node 112, e.g., based on one or more second conditions, such as to a cell where the wireless devices 130 of the first type are accepted, and iii) configure one or more measurements in the wireless device 131, 132 of the first type e.g., the first wireless device 131 or the another wireless device 132, accordingly.

### Not Handing Over Wireless Devices 130 of the First Type, e.g., RedCap UEs, to the Second Network Node 112

If the second network node 112 does not accept wireless devices 130 of the first type, e.g., RedCap UEs, the first network node 111 may refrain from performing handover of wireless devices 130 of the first type, e.g., RedCap UEs, to that node. That may be understood to mean that if the first network node 111 is serving a RedCap UE and conditions which normally may be used to determine whether to attempt a handover to the second network node 112 are fulfilled, the first network node 111 may anyway not perform a handover.

It may be noted that for the first network node 111 may still decide to handover non-wireless devices 130 of the first type, e.g., RedCap UEs to the second network node 112.

And it may also be noted that in case the second network node 112 has multiple serving cells where wireless devices 130 of the first type, e.g., RedCap UEs, may not be accepted only for a subset of them, the first network node 111 may still handover a wireless device of the first type, e.g., RedCap UE, to the second network node 112, but then on a cell of the second network node 112 on which wireless devices 130 of the first type, e.g., RedCap UEs may be accepted.

### Measurement Configuration

If the second network node 112 does not accept wireless devices 130 of the first type, e.g., RedCap UEs, the first network node 111 may configure wireless devices 130 of the first type, e.g., RedCap and wireless devices 130 of the second type, e.g., non-RedCap UEs differently with regards to measurement reporting.

A scenario may be considered where the second network node 112 has a cell on frequency F1 and the second network node 112 has indicated to the first network node 111 that, at least for frequency F1, the second network node 112 does not accept wireless devices 130 of the first type, e.g., RedCap UEs. The first network node 111 may, in response to this, refrain from configuring wireless devices 130 of the first type, e.g., RedCap UEs, to measure frequency F1, while still allowing wireless devices 130 of the second type, e.g., non-RedCap UEs to measure F1.

However, in case there may be multiple cells, e.g., by multiple second network nodes 112, on frequency F1 and at least one of those cells accepts wireless devices 130 of the first type, e.g., RedCap UEs, the first network node 111 may for this reason configure measurements on the F1.

### Default Behavior

Absence of any indication may be interpreted with default behavior. For example, if the second network node 112 has not indicated anything to the first network node 111, the first network node 111 may assume that the second network node 112 does not accept wireless devices 130 of the first type, e.g., RedCap UEs. This may have the benefit that if the second network node 112 does not implement necessary functionality to serve wireless devices 130 of the first type, e.g., RedCap UEs, the first network node 111 may by default assume the second network node 112 does not accept wireless devices 130 of the first type, e.g., RedCap UEs. This may allow the second network node 112 to not even have to implement the indication if the second network node 112 does not support the RedCap feature.

### Handling of Multi-RAT UEs

A particular UE such as the first wireless device 131 may support multiple RATs. For example, a UE such as the first wireless device 131 may support both LTE and NR, and for NR the UE may be wireless device of the first type, e.g., a RedCap UE. In this case, the first network node 111 may hand over the as the first wireless device 131, UE, to the second network node 112, but handover the first wireless device 131, UE, to an LTE frequency where the first wireless device 131, UE, may operate as an LTE UE.

In accordance with the foregoing description, in some embodiments, at least one of the following options may apply: i) the indication may be updatable, ii) the one or more third conditions to which the indication may be subject may be updatable, iii) the indication may be specific to one or more of: a cell, a frequency, a tracking area code, a PLMN, and a type of RAT, iv) the indication may be based on one or more features supported by the first wireless device 131 of the first type, v) the indication may be based on the one or more features, the one or more features comprising whether or not the first wireless device 131 supports 1 Receive branch or antenna port or 2 Receive branches or antenna ports, vi) the indication may further indicate one or more cells where the wireless devices 130 of the first type may be able to be served or not served, vii) the indication may indicate whether or not the second network node 112 accepts to serve wireless devices 130 of the first type by one of: a) its presence, and b) the value of the indication, viii) the wireless devices 130 of the first type may be limited in one or more features with respect to wireless devices 130 of the second type, ix) the wireless devices 130 of the first type may be RedCap UEs, and x) the first action may be at least one of: a) refrain from handing over a wireless device 131, 132 of the first type, to the second network node 112, b) hand over the wireless device 131, 132 of the first type to the second network node 112 based on the one or more second conditions, such as to a cell where the wireless devices 130 of the first type may be accepted, and c) configure one or more measurements in the wireless device 131, 132 of the first type accordingly.

### Action 204

In this Action 204, the first network node 111 may send a further indication, e.g., a second indication, to the first wireless device 131 or the another wireless device 132. The further indication may configure the one or more measurements in the first wireless device 131 of the first type according to the received indication.

### Action 205

In this Action 205, the first network node 111 may receive another indication, e.g., a third indication, from one of the second network node 112 and the first wireless device 131 or the another wireless device 132. The third indication may update the first indication on whether or not the second network node 112 accepts to serve wireless devices 130 of the first type. The determining 202 and the performing 203 may be repeated based on the received third indication.

The determining in Action 202 and the performing in Action 203 may be repeated based on the received third indication.

In some embodiments, wherein when the determining in Action 202 may be repeated based on the third indication, the first action may be at least one of: i) refrain from handing over a further wireless device 133 of the first type to the second network node 112, e.g., based on one or more fourth conditions, ii) hand over the first wireless device 131 or another wireless device 132 of the first type to the second network node 112; this may be, e.g., based on the one or more second conditions, such as to a cell where the wireless devices 130 of the first type are accepted, iii) configure one or more measurements in the first wireless device 131 or another wireless device 132 of the first type, accordingly.

Embodiments of a method, performed by a another node, such as the second network node 112, will now be described with reference to the flowchart depicted in FIG. 3. The method may be understood to be for handling wireless devices, such as the wireless devices 130, e.g., the first wireless device 131. The second network node 112 operates in the communications network 100.

Several embodiments are comprised herein. In some embodiments all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the second network node 112 is depicted in FIG. 3. Examples of these actions and the indications are provided in this document. Some actions may be performed in a different order than that shown FIG. 3. In FIG. 3, actions which may be optional in some examples are depicted with dashed boxes. The detailed description of some of the following corresponds to the same references provided above, in relation to the actions described for the first network node 111 and will thus not be repeated here. For example, a “RedCap UE” or “RedCap type” may be understood to refer to a UE which may have some of the characteristics listed in the background and mentioned in the WID, e.g., supporting narrower Bandwidth (BW) compared to Rel-15 NR UEs, or supporting only one MIMO layer or Rx branch, or supporting only 64 QAM instead of 256 QAM in downlink, or supporting HD-FDD operation within a single carrier.

### Action 301

In this Action 301, the second network node 112 sends the indication, that is, the first indication, to the first network node 111 comprised in the communications network 100, e.g., via the second link 142. The indication indicates whether or not the second network node 112 accepts to serve wireless devices 130 of the first type.

In some embodiments, at least one of: i) the indication may be updatable, ii) the one or more third conditions to which the indication may be subject may be updatable, iii) the indication may be specific to one or more of: a cell, a frequency, a tracking area code, a PLMN, and a type of RAT, iv) the indication may be based on the one or more features supported by the first wireless device 131 of the first type, v) the indication may be based on the one or more features, the one or more features comprising whether or not the first wireless device 131 may support 1 Receive branch or antenna port or 2 Receive branches or antenna ports, vi) the indication may further indicate the one or more cells where the wireless devices 130 of the first type may be able to be served or not served, vii) the indication may indicate whether or not the second network node 112 accepts to serve wireless devices 130 of the first type by one of: i) its presence, and b) the value of the indication, viii) the wireless devices 130 of the first type may be limited in the one or more features with respect to the wireless devices 130 of the second type, ix) the wireless devices 130 of the first type may be RedCap UEs.

In some embodiments, the second network node 112 may be a second radio access network node, and the first network node 111 may be a first radio access network node. In some of such embodiments, the sending 301 of the indication may be performed according to at least one of: i) in the interface between the second network node 112 and the first network node 111, ii) when the interface may be set up, iii) in the message sent after the interface may have been set up, iv) in one of the Served Cell Information NR IE and the Neighbour Information NR IE, v) in the response to the request from the first network node 111, vi) after determining that the first network node 111 supports wireless devices 130 of the first type; that is, with the proviso that the first network node 111 supports wireless devices 130 of the first type, vii) in the handover request message, viii) in the response to the message retrieving the UE context, ix) in the handover procedure, e.g., wherein the second network node 112 may be a source node and the first network node 111 may be a target node; e.g., in a Mobility Restriction List IE, RAT Restriction Information IE, a HANDOVER REQUEST FAILURE, HANDOVER REQUEST ACKNOWLEDGE, and x) during the dual connectivity procedure.

In some embodiments, the second network node 112 may be a core network node and the first network node 111 may be a radio access network node. In some of such embodiments, the sending 301 of the indication may be performed according to at least one of: i) in the IE in a Downlink, DL, Non-access Stratum, NAS, TRANSPORT message, ii) in the INITIAL CONTEXT SETUP REQUEST message, iii) in the general message, iv) in the Mobility Restriction List IE, and v) according to the NGAP specification.

### Action 302

The second network node 112 may send the indication to the first network node 111 to indicate if it accepts the wireless devices 130 of the first type, e.g., RedCap UEs, or not, as described above. If the second network node 112 at first accepts the wireless devices 130 of the first type, e.g., RedCap UEs, but then changes so it may no longer accept the wireless devices 130 of the first type, e.g., RedCap UEs, it may send the indication to the first network node 111 to update the first network node 111 with this information.

In some embodiments, the sent indication in Action 301 may be understood to be the first indication, and in this Action 302, the second network node 112 may send another indication, e.g., the third indication. The third indication may update the first indication on whether or not the second network node 112 accepts to serve wireless devices 130 of the first type.

The third indication may be sent to at least one of the first network node 111 and the first wireless device 131 or another wireless device 132.

### Action 303

If, as mentioned above, the second network node 112 at first may have accepted the wireless devices 130 of the first type, e.g., RedCap UEs, but then changes so it may no longer accept the wireless devices 130 of the first type, e.g., RedCap UEs, it may send the indication to the first network node 111 to update the first network node 111 with this information. Below are different approaches for how to handle the wireless devices 130 of the first type, e.g., RedCap UEs, which may be already connected to the second network node 112 in this situation. That is, below is a description of the actions that the second network node 112 may perform when changing the preference.

In some embodiments, wherein the third indication may indicate that the second network node 112 no longer accepts to serve wireless devices 130 of the first type, the second network node 112 may in this Action 303, perform an action, e.g., a second action.

The performing of the second action may be based on the second network node 112 no longer accepting to serve wireless devices 130 of the first type.

It may be noted that in the text below it will been described how the second network node 112, e.g., the whole node, may change its preference with regards to serving the wireless devices 130 of the first type, e.g., RedCap UEs. However, the methods below may be applied on a per cell-basis. For example, if the second network node 112 no longer wants to serve RedCap UEs on cell A, the second network node may indicate to other nodes that it does not accept (new) RedCap UEs on cell A. The second network node 112 may then, as described below, anyway keep serving the already connected RedCap UEs. Or, as also described below, the second network node 112 may attempt to handover RedCap UEs from cell A to another cell, e.g., to a cell which may accept RedCap UEs.

In a non-limiting example, this may be done during the Xn configuration update procedure as described in the section entitled “How first network node 111 may acquire the indication”

### Continue to Serve Already Connected RedCap UEs

In case the second network node 112 may have indicated to a first network node 111 that it does not accept the wireless devices 130 of the first type, e.g., RedCap UEs, it may still decide to continue to serve any wireless devices 130 of the first type, e.g., RedCap UEs. However, as the second network node 112 may indicate to the first network node 111 that it does not accept the wireless devices 130 of the first type, e.g., RedCap UEs, no new the wireless devices 130 of the first type, e.g., RedCap UEs, may be handed over to the second network node 112. Also, the second network node 112 may also change a system information indication which may make the wireless devices 130 of the first type, e.g., RedCap UEs, not attempting to establish a connection with the second network node 112. This approach of continuing to serve the wireless devices 130 of the first type, e.g., RedCap UEs, may be understood to be beneficial since it may ensure that if there are wireless devices 130 of the first type, e.g., RedCap UEs, connected to the second network node 112 when the second network node 112 changes its preference, it may be enabled to not interrupt the connection for the wireless devices 130 of the first type, e.g., RedCap UEs. However, it may have the drawback that if the second network node 112 suddenly needs to offload wireless devices 130 of the first type, e.g., RedCap UEs, to free up resource, it may not free up those resources quick enough.

In some embodiments, the second action may comprise at least one of: i) handing over one or more wireless devices 130 of the first type currently served by the second network node 112 to the first network node 111 or another network node 113 operating in the communications network 100, and ii) tearing down one or more of respective connections with the one or more wireless devices 130 of the first type currently served by the second network node 112.

The performing of the second action may comprise that the second network node 112 may send yet another indication to any of the devices to be handed over, which sending of the yet another indication may be based on the sending of the third indication. The yet another indication may be, e.g., the system information indication which may make the wireless devices 130 of the first type, e.g., RedCap UEs, not attempting to establish a connection with the second network node 112.

### Handover RedCap UEs to Other Nodes/Cells

Another approach may be that the second network node 112, when it may want to change, or may have already changed, its preference with regards to serving wireless devices 130 of the first type, e.g., RedCap UEs, the node may perform handovers of RedCap UEs to other nodes. This may ensure that the second network node 112 may no longer serve those wireless devices 130 of the first type, e.g., RedCap UEs, may be handed over, while allowing the wireless devices 130 of the first type, e.g., RedCap UEs, to continue being served, but by another node.

Tear Down the Connection with RedCap UEs

Another approach may be that the second network node 112 may tear down the connection for the wireless devices 130 of the first type, e.g., RedCap UEs, when the second network node 112 may no longer be able to accept wireless devices 130 of the first type, e.g., RedCap UEs. This may be achieved by releasing the RRC connection for those wireless devices 130, e.g., UEs. That may result in an interruption for the released wireless devices 130, e.g., UEs, but it may have the benefit that it may quickly ensure that wireless devices 130 of the first type, e.g., RedCap UEs may no longer be served.

### Hybrid

A hybrid of the above approaches is possible. Namely, when the second network node 112 no longer may be able to accept wireless devices 130 of the first type, e.g., RedCap UEs, it may hand over all wireless devices 130 of the first type, e.g., RedCap UEs, for which a handover may be possible for, while keep on serving the RedCap UEs which may not be handed over to any cell.

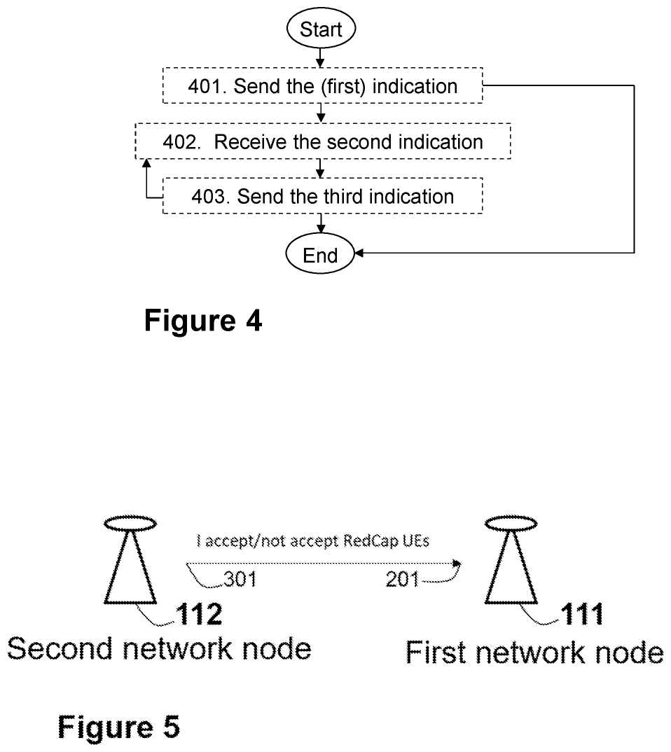

Embodiments of a method, performed by a wireless device, such as the first wireless device 131, will now be described with reference to the flowchart depicted in FIG. 4. The method may be understood to be for handling an indication. The first wireless device 131 may operate in the communications network 100.

The method may comprise the following actions. Examples of these actions and the indications are provided in this document. Several embodiments are comprised herein. In some embodiments all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first wireless device 131 is depicted in FIG. 4. Some actions may be performed in a different order than that shown in FIG. 4. In FIG. 4, optional actions are depicted with dashed lines. The detailed description of some of the following corresponds to the same references provided above, in relation to the actions described for the first node 111 and will thus not be repeated here to simplify the description. For example, a “RedCap UE” or “RedCap type” may be understood to refer to a UE which may have some of the characteristics listed in the background and mentioned in the WID, e.g., supporting narrower Bandwidth (BW) compared to Rel-15 NR UEs, or supporting only one MIMO layer or Rx branch, or supporting only 64 QAM instead of 256 QAM in downlink, or supporting HD-FDD operation within a single carrier.

In some embodiments, the first wireless device 131 may be a 5G UE.

In some embodiments, the first wireless device 131 may be of the first type, e.g., the first wireless device 131 may be a RedCap UE.

In some embodiments, the first network node 111 may be a gNB. The second network node 112 may be another gNB, or an core network node.

### Action 401

In this Action 401, the first wireless device 131 sends the indication, that is, the first indication. The sending of the indication may be to the first network node 111 operating in the communications network 100, e.g., via the first link 141.

The indication may indicate whether or not the second network node 112 accepts to serve wireless devices 130 of the first type.

The first wireless device 131 may have received a corresponding indication from the second network node 112 indicating whether or not the second network node 112 accepts to serve wireless devices 130 of the first type, e.g., via system information.

In some embodiments, at least one of the following may apply: i) the indication may be updatable, ii) the one or more third conditions to which the indication may be subject may be updatable, iii) the indication may be specific to one or more of: a cell, a frequency, a tracking area code, a PLMN, and a type of RAT, iv) the indication may be based on the one or more features supported by the first wireless device 131, wherein the first wireless device 131 is of the first type, v) the indication may be based on the one or more features, the one or more features comprising whether or not the first wireless device 131 supports 1 Receive branch or antenna port or 2 Receive branches or antenna ports, vi) the indication may further indicate the one or more cells where the wireless devices 130 of the first type may be able to be served or not served, vii) the indication may indicate whether or not the second network node 112 accepts to serve wireless devices 130 of the first type by one of: a) its presence, and b) the value of the indication, viii) the first network node 111 may be a first radio access network node, and the second network node 112 may be a second radio access network node; In some of such embodiments, the sending 401 of the indication may be performed according to at least one of: a) in the response to the request from the first network node 111, b) with the proviso that the first network node 111 supports wireless devices 130 of the first type, c) in the handover procedure, e.g., wherein the first network node 111 may be a target node, and d) during the dual connectivity procedure, ix) the wireless devices 130 of the first type may be limited in the one or more features with respect to the wireless devices 130 of the second type, and x) the wireless devices 130 of the first type may be RedCap UEs.

### Action 402

In some embodiments, e.g., wherein the first wireless device 131 may be of the first type, the first wireless device 131 may, in this Action 402, receive, based on the sent indication, the further, e.g., second, indication from the first network node 111. The further indication may configure the one or more measurements in the first wireless device 131 of the first type according to the sent indication. That is, the receiving in this Action 402 of the further, e.g., second indication may be based on the sent indication.

In some embodiments, wherein the first wireless device 131 may be of the first type, the first wireless device 131 may be, based on the sent indication, handed over the to the second network node 112. This may be performed, e.g., based on the one or more second conditions, such as to a cell where the wireless devices 130 of the first type may be accepted.

### Action 403

In some embodiments, e.g., wherein the first wireless device 131 may be of the first type, the first wireless device 131 may be of the first type, the first wireless device 131 may, in this Action 403, send another indication, e.g., the third indication to the first network node 111.

The third indication may be sent to at least one of the first network node 111 or another wireless device 132.

The third indication may update the first indication on whether or not the second network node 112 may accept to serve wireless devices 130 of the first type, and wherein the receiving 402 is repeated based on the sent third indication.

The receiving of Action 402 may be repeated based on the sent third indication.

The performing of the second action may comprise that the first wireless device 131 of the first type, to be handed over to the first network node 111 or to the another network node 113 operating in the communications network 100.

The performing of the second action may comprise that the first wireless device 131 of the first type tear down the one or more of respective connections with the second network node 112.

The performing of the second action may comprise that the first wireless device 131 may receive the yet another indication, based on the sending of the third indication.

FIG. 5 is a schematic representation depicting a non-limiting example of a methods according to embodiments herein. The first network node 111, according to Action 201, receives the indication, that is, the first indication, sent by the second network node 112 according to Action 301. The indication indicates whether or not the second network node 112 accepts to serve the wireless devices 130 of the first type, RedCapUEs in this example.

Certain embodiments disclosed herein may provide one or more of the following technical advantage(s), which may be summarized as follows. Embodiments herein may enable to ensure that unnecessary handovers are not attempted for wireless devices 130 of the first type, e.g., RedCap UEs, to nodes which do not accept wireless devices 130 of the first type, e.g., RedCap UEs. In some embodiments, RRM measurements may be avoided by wireless devices 130 of the first type, e.g., RedCap UEs. As mentioned above, the source first network node 111 may avoid reconfiguring the first wireless device 131, e.g., a UE, when preparing for the handover procedure, which may save energy for both the first wireless device 131, e.g., a UE, and the network.

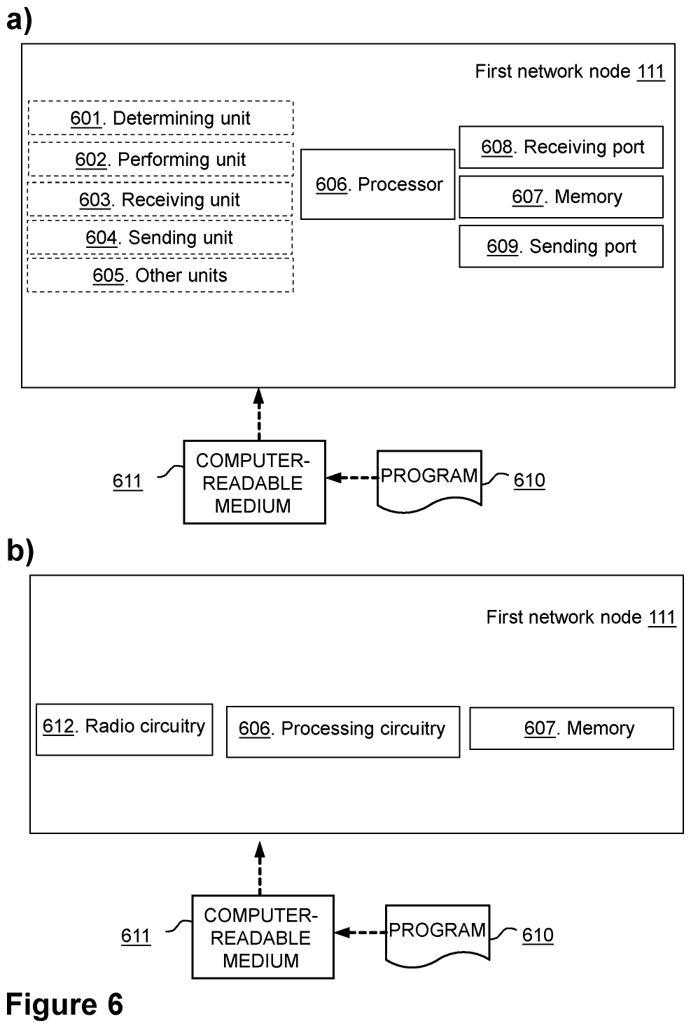

FIG. 6 depicts two different examples in panels a) and b), respectively, of the arrangement that the first network node 111 may comprise. In some embodiments, the first network node 111 may comprise the following arrangement depicted in FIG. 6a. The first network node 111 may be understood to be for handling wireless devices 130. The first network node 111 is configured to operate in the communications network 100.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 111, and will thus not be repeated here. For example, a “RedCap UE” or “RedCap type” may be understood to refer to a UE which may be configured to have some of the characteristics listed in the background and mentioned in the WID, e.g., configured to support narrower Bandwidth (BW) compared to Rel-15 NR UEs, or configured to support only one MIMO layer or Rx branch, or configured to support only 64 QAM instead of 256 QAM in downlink, or configured to support HD-FDD operation within a single carrier.

In FIG. 6, optional units are indicated with dashed boxes.

The first network node 111 is configured to perform the determining of Action 202, e.g. by means of a determining unit 601 within the first network node 111, configured to determine whether or not the second network node 112 configured to be comprised in the communications network 100 accepts to serve wireless devices 130 of the first type.

The first network node 111 is also configured to perform the performing of Action 203, e.g. by means of a performing unit 602, configured to perform the first action based on the result of the determination.

In some embodiments, the determining may be configured to be based on whether or not the first network node 111 may receive the indication from the one of the second network node 112 and the first wireless device 131 configured to be comprised in the communications network 100. The indication may be configured to indicate whether or not the second network node 112 may accept to serve wireless devices 130 of the first type. The determining may be configured to be based on the indication configured to be received.

In some embodiments, at least one of the following may apply: i) the indication may be configured to be updatable, ii) the one or more third conditions to which the indication may be configured to be subject may be configured to be updatable, iii) the indication may be configured to be specific to the one or more of: the cell, the frequency, the tracking area code, the PLMN, and the type of RAT, iv) the indication may be configured to be based on one or more features configured to be supported by the first wireless device 131 of the first type, v) the indication may be configured to be based on the one or more features, the one or more features may be configured to comprise whether or not the first wireless device 131 may be configured to support 1 Receive branch or antenna port or 2 Receive branches or antenna ports, vi) the indication may be further configured to indicate the one or more cells where the wireless devices 130 of the first type may be able to be served or not served, vii) the indication may be configured to indicate whether or not the second network node 112 may accept to serve wireless devices 130 of the first type by one of: a) its presence, and b) the value of the indication, viii) the wireless devices 130 of the first type may be configured to be limited in the one or more features with respect to the wireless devices 130 of the second type, ix) the wireless devices 130 of the first type may be configured to be RedCap UEs, and x) the first action may be configured to be at least one of: a) refrain from handing over the wireless device 131, 132 of the first type, to the second network node 112, b) hand over the wireless device 131, 132 of the first type to the second network node 112 based on the one or more second conditions, and c) configure the one or more measurements in the wireless device 131, 132 of the first type accordingly.

In some embodiments, wherein the first network node 111 may be configured to be a first radio access network node, and the second network node 112 may be configured to be a second radio access network node, the receiving of the indication may be configured to be performed according to at least one of the following: a) in the interface between the second network node 112 and the first network node 111, b) when the interface may be configured to be set up, c) in the message configured to be received after the interface may be configured to have been set up, d) in one of a Served Cell Information NR IE and a Neighbour Information NR IE, e) in the response to the request from the first network node 111, f) with the proviso that the first network node 111 may be configured to support wireless devices 130 of the first type, g) in the handover request message, h) in the response to the message retrieving the UE context, i) in the handover procedure, and j) during the dual connectivity procedure.

The first network node 111 may be further configured to perform the receiving of Action 201, e.g. by means of a receiving unit 603, configured to receive the indication from one of the second network node 112 and the first wireless device 131.

The first network node 111 may be further configured to perform the sending of Action 204, e.g. by means of a sending unit 604, configured to the further indication to the first wireless device 131 or the another wireless device 132. The further indication may be configured to configure the one or more measurements in the first wireless device 131 of the first type according to the indication configured to be received.

The first network node 111 may be further configured to perform the receiving of Action 205, e.g. by means of the receiving unit 603, configured to receive the third indication from the one of the second network node 112 and the first wireless device 131 or the another wireless device 132. The third indication may be configured to update the first indication on whether or not the second network node 112 may be configured to accept to serve wireless devices 130 of the first type. The determining and the performing may be configured to be repeated based on the third indication configured to be received.

Other units 605 may be comprised in the first network node 111.

The embodiments herein in the first network node 111 may be implemented through one or more processors, such as a processor 606 in the first network node 111 depicted in FIG. 6a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 607 comprising one or more memory units. The memory 607 is arranged to be used to store obtained information, store data, configurations, schedulings, and applications etc. to perform the methods herein when being executed in the first network node 111.

In some embodiments, the first network node 111 may receive information from, e.g., any of the wireless devices 130, the second network node 112, and/or the another network node 113 through a receiving port 608. In some embodiments, the receiving port 608 may be, for example, connected to one or more antennas in first network node 111. In other embodiments, the first network node 111 may receive information from another structure in the communications network 100 through the receiving port 608. Since the receiving port 608 may be in communication with the processor 606, the receiving port 608 may then send the received information to the processor 606. The receiving port 608 may also be configured to receive other information.

The processor 606 in the first network node 111 may be further configured to transmit or send information to e.g., any of the wireless devices 130, the second network node 112, the another network node 113 and/or another structure in the communications network 100, through a sending port 609, which may be in communication with the processor 606, and the memory 607.

Those skilled in the art will also appreciate that the units 601-605 described above may refer to a combination of analog and digital circuits, and/or one or more processors configured with software and/or firmware, e.g., stored in memory, that, when executed by the one or more processors such as the processor 606, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 601-1605 described above may be implemented as one or more applications running on one or more processors such as the processor 606.

Thus, the methods according to the embodiments described herein for the first network node 111 may be respectively implemented by means of a computer program 610 product, comprising instructions, i.e., software code portions, which, when executed on at least one processor 606, cause the at least one processor 606 to carry out the actions described herein, as performed by the first network node 111. The computer program 610 product may be stored on a computer-readable storage medium 611. The computer-readable storage medium 611, having stored thereon the computer program 610, may comprise instructions which, when executed on at least one processor 606, cause the at least one processor 606 to carry out the actions described herein, as performed by the first network node 111. In some embodiments, the computer-readable storage medium 611 may be a non-transitory computer-readable storage medium, such as a CD ROM disc, or a memory stick. In other embodiments, the computer program 610 product may be stored on a carrier containing the computer program 610 just described, wherein the carrier is one of an electronic signal, optical signal, radio signal, or the computer-readable storage medium 611, as described above.

The first network node 111 may comprise a communication interface configured to facilitate communications between the first network node 111 and other nodes or devices, e.g., any of the wireless devices 130, the second network node 112, the another network node 113 and/or another structure in the communications network 100. The interface may, for example, include a transceiver configured to transmit and receive radio signals over an air interface in accordance with a suitable standard.

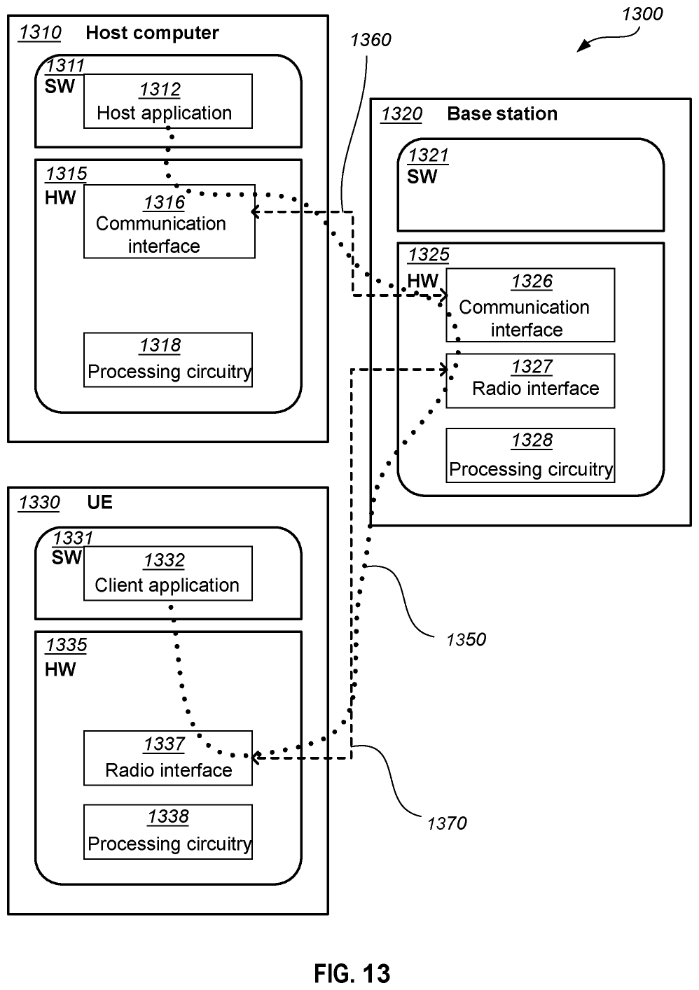

In other embodiments, the first network node 111 may comprise the following arrangement depicted in FIG. 6b. The first network node 111 may comprise a processing circuitry 606, e.g., one or more processors such as the processor 606, in the first network node 111 and the memory 607. The first network node 111 may also comprise a radio circuitry 612, which may comprise e.g., the receiving port 608 and the sending port 609. The processing circuitry 606 may be configured to, or operable to, perform the method actions according to FIG. 2, FIG. 5 and/or FIGS. 13-17, in a similar manner as that described in relation to FIG. 6a. The radio circuitry 612 may be configured to set up and maintain at least a wireless connection with the any of the wireless devices 130, the second network node 112, the another network node 113 and/or another structure in the communications network 100. Circuitry may be understood herein as a hardware component.

Hence, embodiments herein also relate to the first network node 111 operative to operate in the communications network 100. The first network node 111 may comprise the processing circuitry 606 and the memory 607, said memory 607 containing instructions executable by said processing circuitry 606, whereby the first network node 111 is further operative to perform the actions described herein in relation to the first network node 111, e.g., in FIG. 2, FIG. 5 and/or FIGS. 13-17.

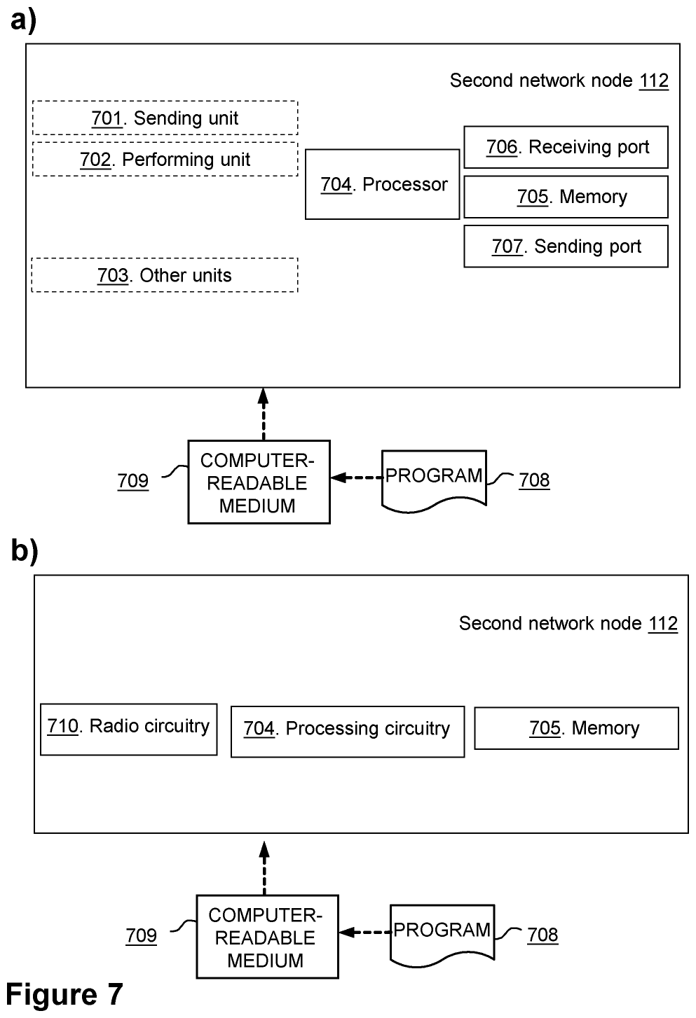

FIG. 7 depicts two different examples in panels a) and b), respectively, of the arrangement that the second network node 112 may comprise. In some embodiments, the second network node 112 may comprise the following arrangement depicted in FIG. 7a. The second network node 112 may be understood to be for handling wireless devices 130. The second network node 112 is configured to operate in the communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second network node 112, and will thus not be repeated here. For example, a “RedCap UE” or “RedCap type” may be understood to refer to a UE which may be configured to have some of the characteristics listed in the background and mentioned in the WID, e.g., configured to support narrower Bandwidth (BW) compared to Rel-15 NR UEs, or configured to support only one MIMO layer or Rx branch, or configured to support only 64 QAM instead of 256 QAM in downlink, or configured to support HD-FDD operation within a single carrier.

In FIG. 7, optional units are indicated with dashed boxes.

The second network node 112 is configured to perform the sending of Action 301, e.g. by means of a sending unit 701, configured to send the indication to the first network node 111 configured to be comprised in the communications network 100. The indication is configured to indicate whether or not the second network node 112 accepts to serve the wireless devices 130 of the first type.

In some embodiments, at least one of the following may apply: i) the indication may be configured to be updatable, ii) the one or more third conditions to which the indication may be configured to be subject may be configured to be updatable, iii) the indication may be configured to be specific to the one or more of: the cell, the frequency, the tracking area code, the PLMN, and the type of RAT, iv) the indication may be configured to be based on the one or more features configured to be supported by the first wireless device 131 of the first type, v) the indication may be configured to be based on the one or more features, the one or more features may be configured to comprise whether or not the first wireless device 131 may be configured to support 1 Receive branch or antenna port or 2 Receive branches or antenna ports, vi) the indication may be further configured to indicate the one or more cells where the wireless devices 130 of the first type may be able to be served or not served, vii) the indication may be configured to indicate whether or not the second network node 112 may accept to serve wireless devices 130 of the first type by one of: a) its presence, and b) the value of the indication, viii) the wireless devices 130 of the first type may be configured to be limited in the one or more features with respect to the wireless devices 130 of the second type, and ix) the wireless devices 130 of the first type may be configured to be RedCap UEs.

In some embodiments, wherein the second network node 112 may be configured to be a second radio access network node and the first network node 111 may be configured to be a first radio access network node, the sending of the indication may be configured to be performed according to at least one of the following: a) in the interface between the second network node 112 and the first network node 111, b) when the interface may be configured to be set up, c) in the message configured to be sent after the interface may be configured to have been set up, d) in one of the Served Cell Information NR IE and the Neighbour Information NR IE, e) in the response to the request from the first network node 111, f) after determining that the first network node 111 may be configured to support wireless devices 130 of the first type, g) in the handover request message, h) in the response to the message configured to retrieve the UE context, i) in the handover procedure, wherein the second network node 112 may be configured to be the source node, and j) during the dual connectivity procedure.

In some embodiments, the indication may be configured to be sent may be the first indication and the second network node 112 may be configured to perform the sending of Action 302, e.g. by means of the sending unit 701, configured to send the third indication configured to update the first indication on whether or not the second network node 112 may be configured to accept to serve wireless devices 130 of the first type.

In some embodiments, the third indication may be configured to indicate that the second network node 112 may no longer accept to serve wireless devices 130 of the first type and the second network node 112 may be configured to perform the performing of Action 303, e.g. by means of a performing unit 702, configured to perform the second action based on the second network node 112 no longer accepting to serve wireless devices 130 of the first type. The second action may be configured to comprise at least one of: i) handing over the one or more wireless devices 130 of the first type configured to be currently served by the second network node 112 to the first network node 111 or the another network node 113 configured to be operating in the communications network 100, and b) tearing down the one or more of respective connections with the one or more wireless devices 130 of the first type configured to be currently served by the second network node 112.

Other units 703 may be comprised in the second network node 112.

The embodiments herein in the second network node 112 may be implemented through one or more processors, such as a processor 704 in the second network node 112 depicted in FIG. 7a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second network node 112.

One such carrier may be in the form of a CD ROM disc. It is however feasible with other data carriers such as a memory stick. The computer program code may furthermore be provided as pure program code on a server and downloaded to the second network node 112.

The second network node 112 may further comprise a memory 705 comprising one or more memory units. The memory 705 is arranged to be used to store obtained information, store data, configurations, schedulings, and applications etc. to perform the methods herein when being executed in the second network node 112.

In some embodiments, the second network node 112 may receive information from, e.g., any of the wireless devices 130, the first network node 111, and/or the another network node 113, through a receiving port 706. In some embodiments, the receiving port 706 may be, for example, connected to one or more antennas in second network node 112. In other embodiments, the second network node 112 may receive information from another structure in the communications network 100 through the receiving port 706. Since the receiving port 706 may be in communication with the processor 704, the receiving port 706 may then send the received information to the processor 704. The receiving port 706 may also be configured to receive other information.

The processor 704 in the second network node 112 may be further configured to transmit or send information to e.g., any of the wireless devices 130, the first network node 111, the another network node 113 and/or another structure in the communications network 100, through a sending port 707, which may be in communication with the processor 704, and the memory 705.

Those skilled in the art will also appreciate that the units 701-703 described above may refer to a combination of analog and digital circuits, and/or one or more processors configured with software and/or firmware, e.g., stored in memory, that, when executed by the one or more processors such as the processor 704, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 701-703 described above may be implemented as one or more applications running on one or more processors such as the processor 704.

Thus, the methods according to the embodiments described herein for the second network node 112 may be respectively implemented by means of a computer program 708 product, comprising instructions, i.e., software code portions, which, when executed on at least one processor 704, cause the at least one processor 704 to carry out the actions described herein, as performed by the second network node 112. The computer program 708 product may be stored on a computer-readable storage medium 709. The computer-readable storage medium 709, having stored thereon the computer program 708, may comprise instructions which, when executed on at least one processor 704, cause the at least one processor 704 to carry out the actions described herein, as performed by the second network node 112. In some embodiments, the computer-readable storage medium 709 may be a non-transitory computer-readable storage medium, such as a CD ROM disc, or a memory stick. In other embodiments, the computer program 708 product may be stored on a carrier containing the computer program 708 just described, wherein the carrier is one of an electronic signal, optical signal, radio signal, or the computer-readable storage medium 709, as described above.

The second network node 112 may comprise a communication interface configured to facilitate communications between the second network node 112 and other nodes or devices, e.g., any of the wireless devices 130, the first network node 111, the another network node 113 and/or another structure in the communications network 100. The interface may, for example, include a transceiver configured to transmit and receive radio signals over an air interface in accordance with a suitable standard.

In other embodiments, the second network node 112 may comprise the following arrangement depicted in FIG. 7b. The second network node 112 may comprise a processing circuitry 704, e.g., one or more processors such as the processor 704, in the second network node 112 and the memory 705. The second network node 112 may also comprise a radio circuitry 710, which may comprise e.g., the receiving port 706 and the sending port 707. The processing circuitry 704 may be configured to, or operable to, perform the method actions according to FIG. 3, FIG. 5 and/or FIGS. 13-17, in a similar manner as that described in relation to FIG. 7a. The radio circuitry 710 may be configured to set up and maintain at least a wireless connection with any of the wireless devices 130, the first network node 111, the another network node 113 and/or another structure in the communications network 100. Circuitry may be understood herein as a hardware component.

Hence, embodiments herein also relate to the second network node 112 operative to operate in the communications network 100. The second network node 112 may comprise the processing circuitry 704 and the memory 705, said memory 705 containing instructions executable by said processing circuitry 704, whereby the second network node 112 is further operative to perform the actions described herein in relation to the second network node 112, e.g., in FIG. 3, FIG. 5 and/or FIGS. 13-17.

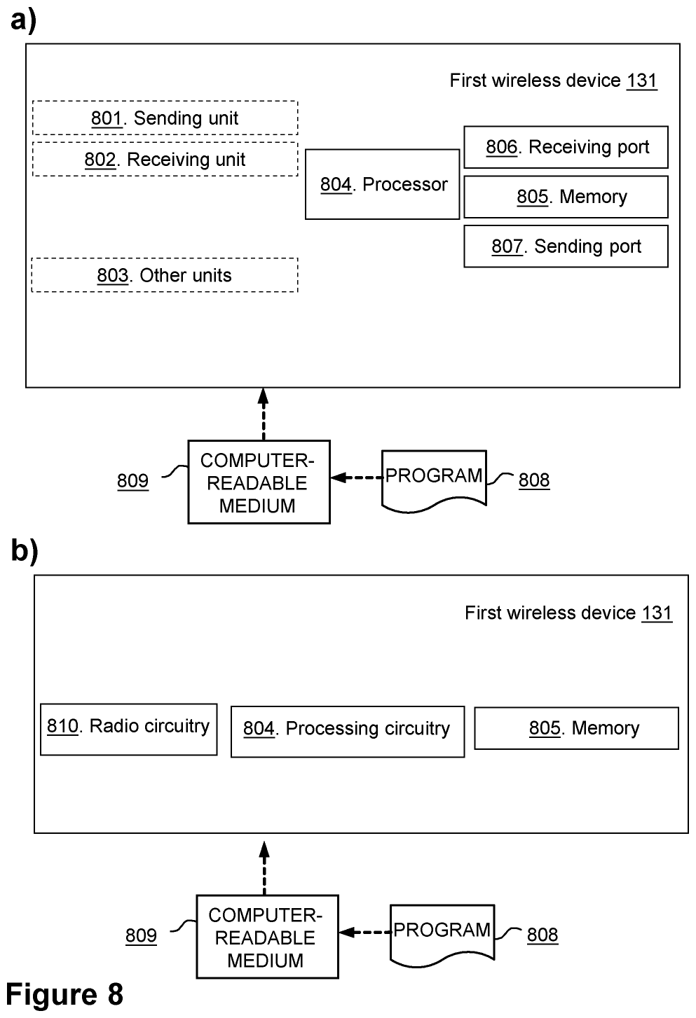

FIG. 8 depicts two different examples in panels a) and b), respectively, of the arrangement that the first wireless device 131 may comprise. In some embodiments, the first wireless device 131 may comprise the following arrangement depicted in FIG. 8a. The second network node 112 may be understood to be for handling an indication. The first wireless device 131 is configured to operate in the communications network 100. Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first wireless device 131, and will thus not be repeated here. For example, a “RedCap UE” or “RedCap type” may be understood to refer to a UE which may be configured to have some of the characteristics listed in the background and mentioned in the WID, e.g., configured to support narrower Bandwidth (BW) compared to Rel-15 NR UEs, or configured to support only one MIMO layer or Rx branch, or configured to support only 64 QAM instead of 256 QAM in downlink, or configured to support HD-FDD operation within a single carrier.

In FIG. 8, optional units are indicated with dashed boxes.

The first wireless device 131 is configured to perform the sending of this Action 401, e.g. by means of a sending unit 801, configured to send the indication to the first network node 111 configured to operate in the communications network 100. The indication is configured to indicate whether or not the second network node 112 accepts to serve wireless devices 130 of the first type.

In some embodiments, wherein the first wireless device 131 may be configured to be of the first type, the first wireless device 131 may be configured to perform the receiving of Action 402, e.g. by means of a receiving unit 802, configured to receive, based on the indication configured to be sent, the further indication from the first network node 111. The further indication may be configured to configure the one or more measurements in the first wireless device 131 of the first type according to the indication configured to be sent.

In some embodiments, wherein the first wireless device 131 may be configured to be of the first type, the first wireless device 131 may be configured to perform the sending of this Action 403, e.g. by means of the sending unit 801, configured to send the third indication to the first network node 111. The third indication may be configured to update the first indication on whether or not the second network node 112 may accepts to serve wireless devices 130 of the first type. The receiving may be configured to be repeated based on the third indication configured to be sent.

In some embodiments, at least one of the following may apply: i) the indication may be configured to be updatable, ii) the one or more third conditions to which the indication may be configured to be subject may be configured to be updatable, iii) the indication may be configured to be specific to the one or more of: the cell, the frequency, the tracking area code, the PLMN, and the type of RAT, iv) the indication may be configured to be based on the one or more features configured to be supported by the first wireless device 131, wherein the first wireless device 131 may be configured to be of the first type, v) the indication may be configured to be based on the one or more features, the one or more features may be configured to comprise whether or not the first wireless device 131 may be configured to support 1 Receive branch or antenna port or 2 Receive branches or antenna ports, vi) the indication may be further configured to indicate the one or more cells where the wireless devices 130 of the first type may be able to be served or not served, vii) the indication may be configured to indicate whether or not the second network node 112 may accept to serve wireless devices 130 of the first type by one of: a) its presence, and b) the value of the indication, viii) the first network node 111 may be configured to be a first radio access network node, and the second network node 112 may be configured to be a second radio access network node, and the sending of the indication may be configured to be performed according to at least one of: a) in the response to the request from the first network node 111, b) with the proviso that the first network node 111 may be configured to support the wireless devices 130 of the first type, c) in the handover procedure, and d) during the dual connectivity procedure, ix) the wireless devices 130 of the first type may be configured to be limited in the one or more features with respect to the wireless devices 130 of the second type, x) the wireless devices 130 of the first type may be configured to be RedCap UEs.

Other units 803 may be comprised in the first wireless device 131.

The embodiments herein in the first wireless device 131 may be implemented through one or more processors, such as a processor 804 in the first wireless device 131 depicted in FIG. 8a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first wireless device 131. One such carrier may be in the form of a CD ROM disc. It is however feasible with other data carriers such as a memory stick. The computer program code may furthermore be provided as pure program code on a server and downloaded to the first wireless device 131.

The first wireless device 131 may further comprise a memory 805 comprising one or more memory units. The memory 805 is arranged to be used to store obtained information, store data, configurations, schedulings, and applications etc. to perform the methods herein when being executed in the first wireless device 131.

In some embodiments, the first wireless device 131 may receive information from, e.g., the first network node 111, any of the wireless devices 130, the second network node 112, and/or the another network node 113, through a receiving port 806. In some embodiments, the receiving port 806 may be, for example, connected to one or more antennas in first wireless device 131. In other embodiments, the first wireless device 131 may receive information from another structure in the communications network 100 through the receiving port 806. Since the receiving port 806 may be in communication with the processor 804, the receiving port 806 may then send the received information to the processor 804. The receiving port 806 may also be configured to receive other information.

The processor 804 in the first wireless device 131 may be further configured to transmit or send information to e.g., the first network node 111, any of the wireless devices 130, the second network node 112, the another network node 113 and/or another structure in the communications network 100, through a sending port 807, which may be in communication with the processor 804, and the memory 805.

Those skilled in the art will also appreciate that the units 801-803 described above may refer to a combination of analog and digital circuits, and/or one or more processors configured with software and/or firmware, e.g., stored in memory, that, when executed by the one or more processors such as the processor 804, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 801-803 described above may be implemented as one or more applications running on one or more processors such as the processor 804.

Thus, the methods according to the embodiments described herein for the first wireless device 131 may be respectively implemented by means of a computer program 808 product, comprising instructions, i.e., software code portions, which, when executed on at least one processor 804, cause the at least one processor 804 to carry out the actions described herein, as performed by the first wireless device 131. The computer program 808 product may be stored on a computer-readable storage medium 809. The computer-readable storage medium 809, having stored thereon the computer program 808, may comprise instructions which, when executed on at least one processor 804, cause the at least one processor 804 to carry out the actions described herein, as performed by the first wireless device 131. In some embodiments, the computer-readable storage medium 809 may be a non-transitory computer-readable storage medium, such as a CD ROM disc, or a memory stick. In other embodiments, the computer program 808 product may be stored on a carrier containing the computer program 808 just described, wherein the carrier is one of an electronic signal, optical signal, radio signal, or the computer-readable storage medium 809, as described above.

The first wireless device 131 may comprise a communication interface configured to facilitate communications between the first wireless device 131 and other nodes or devices, e.g., the first network node 111, any of the wireless devices 130, the second network node 112, the another network node 113 and/or another structure in the communications network 100. The interface may, for example, include a transceiver configured to transmit and receive radio signals over an air interface in accordance with a suitable standard.

In other embodiments, the first wireless device 131 may comprise the following arrangement depicted in FIG. 8b. The first wireless device 131 may comprise a processing circuitry 804, e.g., one or more processors such as the processor 804, in the first wireless device 131 and the memory 805. The first wireless device 131 may also comprise a radio circuitry 810, which may comprise e.g., the receiving port 806 and the sending port 807. The processing circuitry 804 may be configured to, or operable to, perform the method actions according to FIG. 4 and/or FIGS. 13-17, in a similar manner as that described in relation to FIG. 8a. The radio circuitry 810 may be configured to set up and maintain at least a wireless connection with the first network node 111, any of the wireless devices 130, the second network node 112, the another network node 113 and/or another structure in the communications network 100. Circuitry may be understood herein as a hardware component.

Hence, embodiments herein also relate to the first wireless device 131 operative to operate in the communications network 100. The first wireless device 131 may comprise the processing circuitry 804 and the memory 805, said memory 805 containing instructions executable by said processing circuitry 804, whereby the first wireless device 131 is further operative to perform the actions described herein in relation to the first wireless device 131, e.g., in FIG. 4 and/or FIGS. 13-17.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

When using the word “comprise” or “comprising” it shall be interpreted as non-limiting, i.e. meaning “consist at least of”.

A processor may be understood herein as a hardware component.

The embodiments herein are not limited to the above described preferred embodiments. Various alternatives, modifications and equivalents may be used. Therefore, the above embodiments should not be taken as limiting the scope of the invention.

### Examples of, or Related to, Embodiments Herein

Examples related to embodiments herein may be as follows.

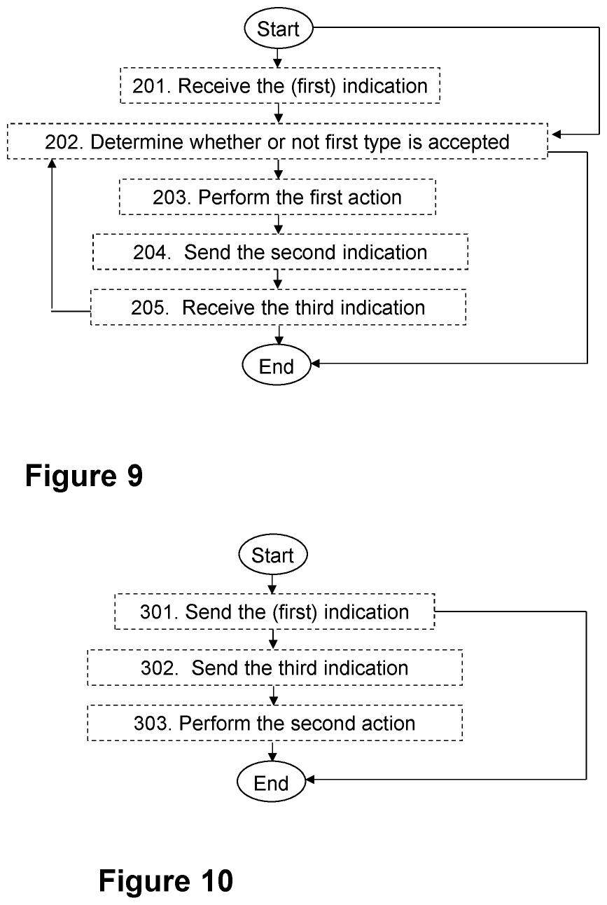

FIG. 9 depicts an example of a method performed by the first network node 111, related to embodiments herein. The description of the actions depicted is the same as that provided in relation to FIG. 2, with the exception that all actions may be optionally performed. The actions may be performed by the first network node 111, as described in relation to FIG. 6, with the exception that all units 601-605 may be optionally configured.

FIG. 10 depicts an example of a method performed by the second network node 112, related to embodiments herein. The description of the actions depicted is the same as that provided in relation to FIG. 3, with the exception that all actions may be optionally performed. The actions may be performed by the second network node 112, as described in relation to FIG. 7, with the exception that all units 701-703 may be optionally configured.

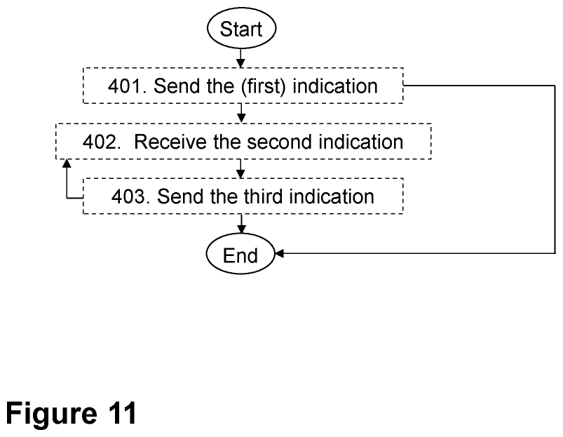

FIG. 11 depicts an example of a method performed by the first wireless device 131, related to embodiments herein. The description of the actions depicted is the same as that provided in relation to FIG. 4, with the exception that all actions may be optionally performed. The actions may be performed by the first wireless device 131, as described in relation to FIG. 8, with the exception that all units 801-803 may be optionally configured.

The following are selected examples related to embodiments herein:

Example 1. A method performed by a first network node (111), the method being for handling wireless devices (130), the first network node (111) operating in a communications network (100), the method comprising:
determining (202) whether or not a second network node (112) comprised in the communications network (100) accepts to serve wireless devices (130) of a first type, and
performing (203) a first action based on a result of the determination.
   Example 2. The method according to example 1, wherein the first action is at least one of:
i. refrain from handing over a wireless device (131, 132) of the first type e.g., a first wireless device (131) or another wireless device (132), to the second network node (112), e.g., based on one or more first conditions,
ii. hand over the wireless device (131, 132) of the first type e.g., a first wireless device (131) or another wireless device (132), to the second network node (112), e.g., based on one or more second conditions, such as to a cell where the wireless devices (130) of the first type are accepted,
iii. configure one or more measurements in the wireless device (131, 132) of the first type e.g., a first wireless device (131) or another wireless device (132), accordingly.
   Example 3. The method according to any of examples 1-2, wherein the determining (202) is based on whether or not the first network node (111) receives an indication from one of the second network node (112) and a first wireless device (131) comprised in the communications network (100), the indication indicating whether or not the second network node (112) accepts to serve wireless devices (130) of the first type, and wherein the determining (202) is based on the received indication.
   Example 4. The method according to example 3, further comprising:
receiving (201) the indication from one of the second network node (112) and the first wireless device (131), and wherein the determining (202) is based on the received indication.
   Example 5. The method according to any of examples 3-4, wherein at least one of:
i. the indication is updatable, and
ii. one or more third conditions to which the indication is subject are updatable.
   Example 6. The method according to any of examples 3-5, wherein at least one of:
i. the indication is specific to one or more of: a cell, a frequency, a tracking area code, a Public Land Mobile Network, and a type of Radio Access Technology, and
ii. the indication is based on one or more features supported by a first wireless device (131) of the first type.
   Example 7. The method according to any of examples 3-6, wherein the indication further indicates the one or more cells where the wireless devices (130) of the first type are able to be served or not served.
   Example 8. The method according to any of examples 3-7, wherein the first network node (111) is a first radio access network node, and the second network node (112) is a second radio access network node, and wherein the receiving (201) of the indication is performed according to at least one of:
in an interface between the second network node (112) and the first network node (111),
when the interface is set up,
in a message received after the interface has been set up,
in one of a Served Cell Information NR IE or a Neighbour Information NR IE,
in a response to a request from the first network node (111),
with the proviso that the first network node (111) supports wireless devices (130) of the first type,
in a handover request message,
in a response to a message retrieving a UE context,
in a handover procedure, e.g., wherein the first network node (111) is a target node; e.g., in a Mobility Restriction List IE, RAT Restriction Information IE, a HANDOVER REQUEST FAILURE, HANDOVER REQUEST ACKNOWLEDGE, and
during a dual connectivity procedure.

Example 9. The method according to any of examples 3-7, wherein the first network node (111) is a radio access network node and the second network node (112) is a core network node, and wherein the receiving (201) of the indication is performed according to at least one of:
in an IE in a Downlink, DL, Non-access Stratum, NAS, TRANSPORT message,
in an INITIAL CONTEXT SETUP REQUEST message,
in a general message,
in a Mobility Restriction List IE, and
according to an NGAP specification.
   Example 10. The method according to any of examples 3-9, wherein the second network node (112) is a second radio access network node, and wherein the receiving (201) of the indication is performed in system information.
   Example 11. The method according to any of examples 3-10, wherein the indication indicates whether or not the second network node (112) accepts to serve wireless devices (130) of the first type by one of:
its presence,
a value of the indication.
   Example 12. The method according to any of examples 3-11, further comprising:
sending (204) a further, e.g., second indication to the first wireless device (131) or another wireless device (132), wherein the further indication configures one or more measurements in the first wireless device (131) of the first type according to the received indication.
   Example 13. The method according to any of examples 3-12, further comprising:
receiving (205) a third indication from one of the second network node (112) and the first wireless device (131) or another wireless device (132), the third indication updating the first indication on whether or not the second network node (112) accepts to serve wireless devices (130) of the first type, and wherein the determining (202) and the performing (203) are repeated based on the received third indication.
   Example 14. The method according to examples 13, wherein when the determining (202) is repeated based on the third indication, the first action is at least one of:
i. refrain from handing over a further wireless device (133) of the first type to the second network node (112), e.g., based on one or more fourth conditions,
ii. hand over the first wireless device (131) or another wireless device (132) of the first type to the second network node (112), e.g., based on one or more second conditions, such as to a cell where the wireless devices (130) of the first type are accepted,
iii. configure one or more measurements in the first wireless device (131) or another wireless device (132) of the first type, accordingly.
   Example 15. The method according to example any of examples 3-14, wherein the wireless devices (130) of the first type are limited in one or more features with respect to wireless devices (130) of a second type.
   Example 16. The method according to example 15, wherein the wireless devices (130) of the first type are Reduced Capability, RedCap, User Equipments, UEs.
   Example 17. A method performed by a second network node (112), the method being for handling wireless devices (130), the second network node (112) operating in a communications network (100), the method comprising:
sending (301) an indication to a first network node (111) comprised in the communications network (100), the indication indicating whether or not the second network node (112) accepts to serve wireless devices (130) of a first type.
   Example 18. The method according to example 17, wherein at least one of:
i. the indication is updatable, and
ii. one or more third conditions to which the indication is subject are updatable.
   Example 19. The method according to any of examples 17-18, wherein at least one of:
i. the indication is specific to one or more of: a cell, a frequency, a tracking area code, a Public Land Mobile Network, and a type of Radio Access Technology, and
ii. the indication is based on one or more features supported by a first wireless device (131) of a first type.
   Example 20. The method according to example any of examples 17-19, wherein the wireless 30 devices (130) of the first type are limited in one or more features with respect to wireless devices (130) of a second type.
   Example 21. The method according to example 20, wherein the wireless devices (130) of the first type are Reduced Capability, RedCap, User Equipments, UEs.
   Example 22. The method according to any of examples 17-21, wherein the indication further indicates the one or more cells where the wireless devices (130) of the first type are able to be served or not served.
   Example 23. The method according to any of examples 17-22, wherein the second network node (112) is a second radio access network node, and the first network node (111) is a first radio access network node, and wherein the sending (301) of the indication is performed according to at least one of:
in an interface between the second network node (112) and the first network node (111),
when the interface is set up,
in a message sent after the interface has been set up,
in one of a Served Cell Information NR IE and a Neighbour Information NR IE,
in a response to a request from the first network node (111),
after determining that the first network node (111) supports wireless devices (130) of the first type,
in a handover request message,
in a response to a message retrieving a UE context,
in a handover procedure, wherein the second network node (112) is a source node; e.g., in a Mobility Restriction List IE, RAT Restriction Information IE, a HANDOVER REQUEST FAILURE, HANDOVER REQUEST ACKNOWLEDGE, and
during a dual connectivity procedure.
   Example 24. The method according to any of examples 17-23, wherein the second network node (112) is a core network node, and the first network node (111) is a first radio access network node, and wherein the sending (301) of the indication is performed according to at least one of:
in an IE in a Downlink, DL, Non-access Stratum, NAS, TRANSPORT message,
in an INITIAL CONTEXT SETUP REQUEST message,
in a general message,
in a Mobility Restriction List IE,
after receiving a PATH SWITCH REQUEST from a new node, and
according to an NGAP specification.
   Example 25. The method according to any of examples 17-24, wherein the indication indicates whether or not the second network node (112) accepts to serve wireless devices (130) of the first type by one of:
its presence,
a value of the indication.
   Example 26. The method according to any of examples 17-25, wherein the sent indication is a first indication, and wherein the method further comprises:
sending (302) a third indication updating the first indication on whether or not the second network node (112) accepts to serve wireless devices (130) of the first type.
   Example 27. The method according to example 26, wherein the third indication indicates that the second network node (112) no longer accepts to serve wireless devices (130) of the first type, and wherein the method further comprises:
performing (303) a second action, based on the second network node (112) no longer accepting to serve wireless devices (130) of the first type.
   Example 28. The method according to example 27, wherein the second action comprises at least one of:
i. handing over one or more wireless devices (130) of the first type currently served by the second network node (112) to the first network node (111) or another network node (113) operating in the communications network (100), and
ii. tearing down one or more of respective connections with the one or more wireless devices (130) of the first type currently served by the second network node (112).
   Example 29. A method performed by a first wireless device (131), the first wireless device (131) operating in a communications network (100), the method comprising:
sending (401) an indication to a first network node (111) operating in the communications network (100), the indication indicating whether or not a second network node (112) accepts to serve wireless devices (130) of the first type.
   Example 30. The method according to example 29, wherein the first wireless device (131) is of the first type and wherein the method further comprises:
receiving (402), based on the sent indication, a further, e.g., second, indication from the second network node (112), wherein the further indication configures one or more measurements in the first wireless device (131) of the first type according to the sent indication.
   Example 31. The method according to any of examples 29-30, wherein the first wireless device (131) is of the first type, and wherein the first wireless device (131) is, based on the sent indication, handed over the to the second network node (112), e.g., based on one or more second conditions, such as to a cell where the wireless devices (130) of the first type are accepted.
   Example 32. The method according to any of examples 29-31, wherein at least one of:
i. the indication is updatable, and
ii. one or more third conditions to which the indication is subject are updatable.
   Example 33. The method according to any of examples 29-32, wherein at least one of:
i. the indication is specific to one or more of: a cell, a frequency, a tracking area code, a Public Land Mobile Network, and a type of Radio Access Technology, and
ii. the indication is based on one or more features supported by a first wireless device (131) of the first type.
   Example 34. The method according to any of examples 29-33, wherein the indication further indicates the one or more cells where wireless devices (130) of the first type are able to be served or not served.
   Example 35. The method according to any of examples 29-34, wherein the first network node (111) is a first radio access network node, and the second network node (112) is a second radio access network node, and wherein the sending (401) of the indication is performed according to at least one of:
in a response to a request from the first network node (111),
with the proviso that the first network node (111) supports wireless devices (130) of the first type,
in a handover procedure, e.g., wherein the first network node (111) is a target node, and
during a dual connectivity procedure.
   Example 36. The method according to any of examples 29-35, wherein the indication indicates whether or not the second network node (112) accepts to serve wireless devices (130) of the first type by one of:
its presence,
a value of the indication.
   Example 37. The method according to any of examples 29-36, further comprising:
sending (403) a third indication to the first network node (111), the third indication updating the first indication on whether or not the second network node (112) accepts to serve wireless devices (130) of the first type, and wherein the receiving (402) is repeated based on the sent third indication.
   Example 38. The method according to example any of examples 29-37, wherein the wireless devices (130) of the first type are limited in one or more features with respect to wireless devices (130) of a second type.
   Example 39. The method according to example 38, wherein the wireless devices (130) of the first type are Reduced Capability, RedCap, User Equipments, UEs.

### Further Extensions and Variations

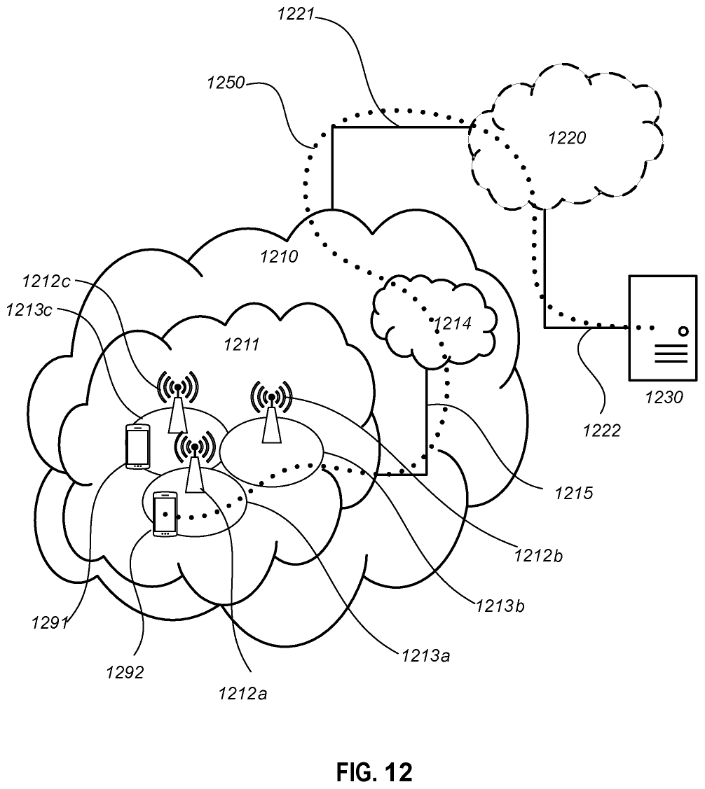

FIG. 12: Telecommunication Network Connected Via an Intermediate Network to a Host Computer in Accordance with Some Embodiments

With reference to FIG. 12, in accordance with an embodiment, a communication system includes telecommunication network 1210 such as the communications network 100, for example, a 3GPP-type cellular network, which comprises access network 1211, such as a radio access network, and core network 1214. Access network 1211 comprises a plurality of network nodes such as any or all of the first network node 111, the second network node 112 and the another network node 113. For example, base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to core network 1214 over a wired or wireless connection 1215. A plurality of wireless devices, such as the first wireless device 131, are comprised in the communications network 100. In FIG. 12, a first UE 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212. Any of the UEs 1291, 1292 are examples of the first wireless device 131.

Telecommunication network 1210 is itself connected to host computer 1230, which may be embodied in the hardware and/or software of a standalone server, a cloud-implemented server, a distributed server or as processing resources in a server farm. Host computer 1230 may be under the ownership or control of a service provider, or may be operated by the service provider or on behalf of the service provider. Connections 1221 and 1222 between telecommunication network 1210 and host computer 1230 may extend directly from core network 1214 to host computer 1230 or may go via an optional intermediate network 1220. Intermediate network 1220 may be one of, or a combination of more than one of, a public, private or hosted network; intermediate network 1220, if any, may be a backbone network or the Internet; in particular, intermediate network 1220 may comprise two or more sub-networks (not shown).

The communication system of FIG. 12 as a whole enables connectivity between the connected UEs 1291, 1292 and host computer 1230. The connectivity may be described as an over-the-top (OTT) connection 1250. Host computer 1230 and the connected UEs 1291, 1292 are configured to communicate data and/or signaling via OTT connection 1250, using access network 1211, core network 1214, any intermediate network 1220 and possible further infrastructure (not shown) as intermediaries. OTT connection 1250 may be transparent in the sense that the participating communication devices through which OTT connection 1250 passes are unaware of routing of uplink and downlink communications. For example, base station 1212 may not or need not be informed about the past routing of an incoming downlink communication with data originating from host computer 1230 to be forwarded (e.g., handed over) to a connected UE 1291. Similarly, base station 1212 need not be aware of the future routing of an outgoing uplink communication originating from the UE 1291 towards the host computer 1230.

In relation to FIGS. 13, 14, 15, 16, and 17, which are described next, it may be understood that a UE is an example of the first wireless device 131, and that any description provided for the UE equally applies to the first wireless device 131. It may be also understood that the base station is an example of any or all of the first network node 111, the second network node 112 and the another network node 113, and that any description provided for the base station equally applies to any or all of the first network node 111, the second network node 112 and the another network node 113.

FIG. 13: Host computer communicating via a base station with a user equipment over a partially wireless connection in accordance with some embodiments Example implementations, in accordance with an embodiment, of the first wireless device 131, e.g., a UE, the first network node 111 and/or the second network node 112, e.g., a base station and host computer discussed in the preceding paragraphs will now be described with reference to FIG. 13. In communication system 1300, such as the communications network 100, host computer 1310 comprises hardware 1315 including communication interface 1316 configured to set up and maintain a wired or wireless connection with an interface of a different communication device of communication system 1300. Host computer 1310 further comprises processing circuitry 1318, which may have storage and/or processing capabilities. In particular, processing circuitry 1318 may comprise one or more programmable processors, application-specific integrated circuits, field programmable gate arrays or combinations of these (not shown) adapted to execute instructions. Host computer 1310 further comprises software 1311, which is stored in or accessible by host computer 1310 and executable by processing circuitry 1318.

Software 1311 includes host application 1312. Host application 1312 may be operable to provide a service to a remote user, such as UE 1330 connecting via OTT connection 1350 terminating at UE 1330 and host computer 1310. In providing the service to the remote user, host application 1312 may provide user data which is transmitted using OTT connection 1350. Communication system 1300 further includes the first network node 111 and/or the second network node 112, exemplified in FIG. 13 as a base station 1320 provided in a telecommunication system and comprising hardware 1325 enabling it to communicate with host computer 1310 and with UE 1330. Hardware 1325 may include communication interface 1326 for setting up and maintaining a wired or wireless connection with an interface of a different communication device of communication system 1300, as well as radio interface 1327 for setting up and maintaining at least wireless connection 1370 with the first wireless device 131, exemplified in FIG. 13 as a UE 1330 located in a coverage area (not shown in FIG. 13) served by base station 1320. Communication interface 1326 may be configured to facilitate connection 1360 to host computer 1310. Connection 1360 may be direct or it may pass through a core network (not shown in FIG. 13) of the telecommunication system and/or through one or more intermediate networks outside the telecommunication system. In the embodiment shown, hardware 1325 of base station 1320 further includes processing circuitry 1328, which may comprise one or more programmable processors, application-specific integrated circuits, field programmable gate arrays or combinations of these (not shown) adapted to execute instructions. Base station 1320 further has software 1321 stored internally or accessible via an external connection.

Communication system 1300 further includes UE 1330 already referred to. Its hardware 1335 may include radio interface 1337 configured to set up and maintain wireless connection 1370 with a base station serving a coverage area in which UE 1330 is currently located. Hardware 1335 of UE 1330 further includes processing circuitry 1338, which may comprise one or more programmable processors, application-specific integrated circuits, field programmable gate arrays or combinations of these (not shown) adapted to execute instructions. UE 1330 further comprises software 1331, which is stored in or accessible by UE 1330 and executable by processing circuitry 1338. Software 1331 includes client application 1332. Client application 1332 may be operable to provide a service to a human or non-human user via UE 1330, with the support of host computer 1310. In host computer 1310, an executing host application 1312 may communicate with the executing client application 1332 via OTT connection 1350 terminating at UE 1330 and host computer 1310. In providing the service to the user, client application 1332 may receive request data from host application 1312 and provide user data in response to the request data. OTT connection 1350 may transfer both the request data and the user data. Client application 1332 may interact with the user to generate the user data that it provides.

It is noted that host computer 1310, base station 1320 and UE 1330 illustrated in FIG. 13 may be similar or identical to host computer 1230, one of base stations 1212a, 1212b, 1212c and one of UEs 1291, 1292 of FIG. 12, respectively. This is to say, the inner workings of these entities may be as shown in FIG. 13 and independently, the surrounding network topology may be that of FIG. 12.

In FIG. 13, OTT connection 1350 has been drawn abstractly to illustrate the communication between host computer 1310 and UE 1330 via base station 1320, without explicit reference to any intermediary devices and the precise routing of messages via these devices. Network infrastructure may determine the routing, which it may be configured to hide from UE 1330 or from the service provider operating host computer 1310, or both. While OTT connection 1350 is active, the network infrastructure may further take decisions by which it dynamically changes the routing (e.g., on the basis of load balancing consideration or reconfiguration of the network).

Wireless connection 1370 between UE 1330 and base station 1320 is in accordance with the teachings of the embodiments described throughout this disclosure. One or more of the various embodiments improve the performance of OTT services provided to UE 1330 using OTT connection 1350, in which wireless connection 1370 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1350 between host computer 1310 and UE 1330, in response to variations in the measurement results. The measurement procedure and/or the network functionality for reconfiguring OTT connection 1350 may be implemented in software 1311 and hardware 1315 of host computer 1310 or in software 1331 and hardware 1335 of UE 1330, or both. In embodiments, sensors (not shown) may be deployed in or in association with communication devices through which OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of OTT connection 1350 may include message format, retransmission settings, preferred routing etc.; the reconfiguring need not affect base station 1320, and it may be unknown or imperceptible to base station 1320. Such procedures and functionalities may be known and practiced in the art. In certain embodiments, measurements may involve proprietary UE signaling facilitating host computer 1310's measurements of throughput, propagation times, latency and the like. The measurements may be implemented in that software 1311 and 1331 causes messages to be transmitted, in particular empty or ‘dummy’ messages, using OTT connection 1350 while it monitors propagation times, errors etc.

The first network node embodiments relate to FIG. 2, FIG. 5, FIG. 6, and FIGS. 13-17.

The first network node 111 may also be configured to communicate user data with a host application unit in a host computer 1310, e.g., via another link such as 1350.

The first network node 111 may comprise an arrangement as shown in FIG. 6 or in FIG. 13.

The second network node embodiments relate to FIG. 3, FIG. 5, FIGS. 7, and FIGS. 13-17.

The second network node 112 may also be configured to communicate user data with a host application unit in a host computer 1310, e.g., via another link such as 1350.

The second network node 112 may comprise an arrangement as shown in FIG. 7 or in FIG. 13.

The wireless device embodiments relate to FIG. 4, FIG. 8 and FIGS. 13-17.

The first wireless device 131 may also be configured to communicate user data with a host application unit in a host computer 1310, e.g., via another link such as 1350.

The first wireless device 131 may comprise an arrangement as shown in FIG. 8 or in FIG. 13.

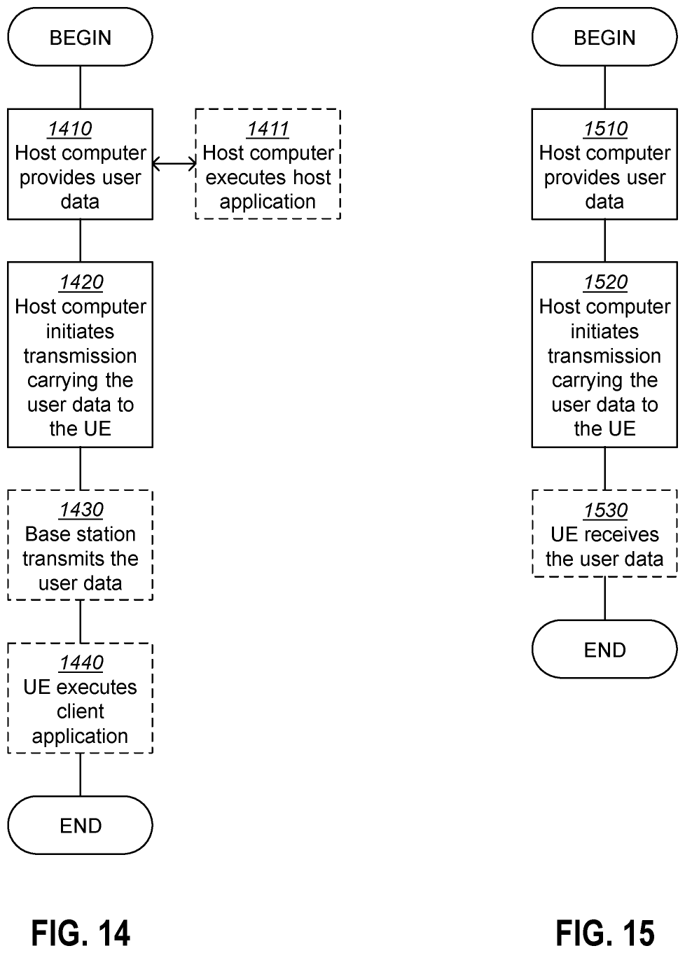

FIG. 14: Methods implemented in a communication system including a host computer, a base station and a user equipment in accordance with some embodiments FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1410, the host computer provides user data. In substep 1411 (which may be optional) of step 1410, the host computer provides the user data by executing a host application. In step 1420, the host computer initiates a transmission carrying the user data to the UE. In step 1430 (which may be optional), the base station transmits to the UE the user data which was carried in the transmission that the host computer initiated, in accordance with the teachings of the embodiments described throughout this disclosure. In step 1440 (which may also be optional), the UE executes a client application associated with the host application executed by the host computer.

FIG. 15: Methods implemented in a communication system including a host computer, a base station and a user equipment in accordance with some embodiments FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1510 of the method, the host computer provides user data. In an optional substep (not shown) the host computer provides the user data by executing a host application. In step 1520, the host computer initiates a transmission carrying the user data to the UE. The transmission may pass via the base station, in accordance with the teachings of the embodiments described throughout this disclosure. In step 1530 (which may be optional), the UE receives the user data carried in the transmission.

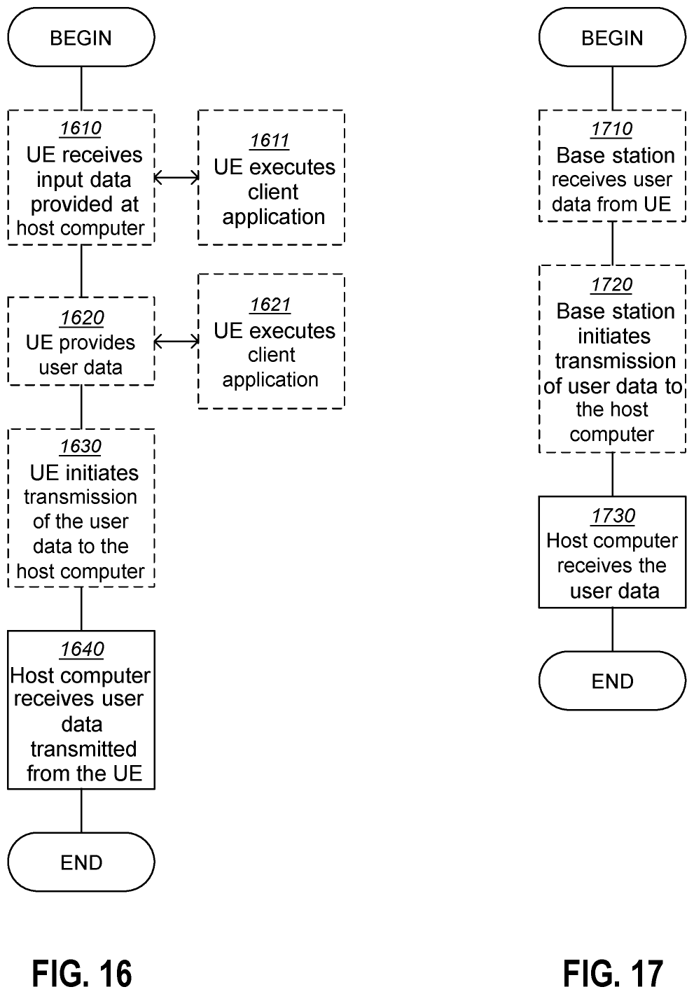

FIG. 16: Methods implemented in a communication system including a host computer, a base station and a user equipment in accordance with some embodiments FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1610 (which may be optional), the UE receives input data provided by the host computer. Additionally or alternatively, in step 1620, the UE provides user data. In substep 1621 (which may be optional) of step 1620, the UE provides the user data by executing a client application. In substep 1611 (which may be optional) of step 1610, the UE executes a client application which provides the user data in reaction to the received input data provided by the host computer. In providing the user data, the executed client application may further consider user input received from the user. Regardless of the specific manner in which the user data was provided, the UE initiates, in substep 1630 (which may be optional), transmission of the user data to the host computer. In step 1640 of the method, the host computer receives the user data transmitted from the UE, in accordance with the teachings of the embodiments described throughout this disclosure.

FIG. 17: Methods implemented in a communication system including a host computer, a base station and a user equipment in accordance with some embodiments FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1710 (which may be optional), in accordance with the teachings of the embodiments described throughout this disclosure, the base station receives user data from the UE. In step 1720 (which may be optional), the base station initiates transmission of the received user data to the host computer. In step 1730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by any of the first network node 111 and/or the second network node 112.
5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the actions described herein as performed by any of the first network node 111 and/or the second network node 112.
   6. The communication system of embodiment 5, further including the base station.
   7. The communication system of embodiment 6, further including the UE, wherein the UE is configured to communicate with the base station.
   8. The communication system of embodiment 7, wherein:
the processing circuitry of the host computer is configured to execute a host application, thereby providing the user data; and
the UE comprises processing circuitry configured to execute a client application associated with the host application.
   11. A method implemented in a base station, comprising one or more of the actions described herein as performed by any of the first network node 111 and/or the second network node 112.
   15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the actions described herein as performed by any of the first network node 111 and/or the second network node 112.
   16. The method of embodiment 15, further comprising:
at the base station, transmitting the user data.
   17. The method of embodiment 16, wherein the user data is provided at the host computer by executing a host application, the method further comprising:
at the UE, executing a client application associated with the host application.
   21. A user equipment (UE) configured to communicate with a base station, the UE comprising a radio interface and processing circuitry configured to perform one or more of the actions described herein as performed by the first wireless device 131.
   25. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's processing circuitry configured to perform one or more of the actions described herein as performed by the first wireless device 131.
   26. The communication system of embodiment 25, further including the UE.
   27. The communication system of embodiment 26, wherein the cellular network further includes a base station configured to communicate with the UE.
   28. The communication system of embodiment 26 or 27, wherein:
the processing circuitry of the host computer is configured to execute a host application, thereby providing the user data; and
the UE's processing circuitry is configured to execute a client application associated with the host application.
   31. A method implemented in a user equipment (UE), comprising one or more of the actions described herein as performed by the first wireless device 131.
   35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs one or more of the actions described herein as performed by the first wireless device 131.
   36. The method of embodiment 35, further comprising:
at the UE, receiving the user data from the base station.
   41. A user equipment (UE) configured to communicate with a base station, the UE comprising a radio interface and processing circuitry configured to perform one or more of the actions described herein as performed by the first wireless device 131.
   45. A communication system including a host computer comprising:
a communication interface configured to receive user data originating from a transmission from a user equipment (UE) to a base station,
wherein the UE comprises a radio interface and processing circuitry, the UE's processing circuitry configured to: perform one or more of the actions described herein as performed by the first wireless device 131.
   46. The communication system of embodiment 45, further including the UE.
   47. The communication system of embodiment 46, further including the base station, wherein the base station comprises a radio interface configured to communicate with the UE and a communication interface configured to forward to the host computer the user data carried by a transmission from the UE to the base station.
   48. The communication system of embodiment 46 or 47, wherein:
the processing circuitry of the host computer is configured to execute a host application; and
the UE's processing circuitry is configured to execute a client application associated with the host application, thereby providing the user data.
   49. The communication system of embodiment 46 or 47, wherein:
the processing circuitry of the host computer is configured to execute a host application, thereby providing request data; and
the UE's processing circuitry is configured to execute a client application associated with the host application, thereby providing the user data in response to the request data.
   51. A method implemented in a user equipment (UE), comprising one or more of the actions described herein as performed by the first wireless device 131.
   52. The method of embodiment 51, further comprising:
providing user data; and
forwarding the user data to a host computer via the transmission to the base station.
   55. A method implemented in a communication system including a host computer, a base station and a user equipment (UE), the method comprising:
at the host computer, receiving user data transmitted to the base station from the UE, wherein the UE performs one or more of the actions described herein as performed by the first wireless device 131.
   56. The method of embodiment 55, further comprising:
at the UE, providing the user data to the base station.
   57. The method of embodiment 56, further comprising:
at the UE, executing a client application, thereby providing the user data to be transmitted; and
at the host computer, executing a host application associated with the client application.
   58. The method of embodiment 56, further comprising:
at the UE, executing a client application; and
at the UE, receiving input data to the client application, the input data being provided at the host computer by executing a host application associated with the client application,
wherein the user data to be transmitted is provided by the client application in response to the input data.
   61. A base station configured to communicate with a user equipment (UE), the base station comprising a radio interface and processing circuitry configured to perform one or more of the actions described herein as performed by any of the first network node 111 and/or the second network node 112.
   65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by any of the first network node 111 and/or the second network node 112.
   66. The communication system of embodiment 65, further including the base station.
   67. The communication system of embodiment 66, further including the UE, wherein the UE is configured to communicate with the base station.
   68. The communication system of embodiment 67, wherein:
the processing circuitry of the host computer is configured to execute a host application;
the UE is configured to execute a client application associated with the host application, thereby providing the user data to be received by the host computer.
   71. A method implemented in a base station, comprising one or more of the actions described herein as performed by any of the first network node 111 and/or the second network node 112.
   75. A method implemented in a communication system including a host computer, a base station and a user equipment (UE), the method comprising:
at the host computer, receiving, from the base station, user data originating from a transmission which the base station has received from the UE, wherein the UE performs one or more of the actions described herein as performed by the first wireless device 131.
   76. The method of embodiment 75, further comprising:
at the base station, receiving the user data from the UE.
   77. The method of embodiment 76, further comprising:
at the base station, initiating a transmission of the received user data to the host computer.

1-26. (canceled)

27. A method, performed by a first network node, for handling wireless devices, the first network node operating in a communications network and the method comprising:
determining whether or not a second network node comprised in the communications network accepts to serve wireless devices of a first type; and
performing a first action based on a result of the determination.

28. The method according to claim 27, wherein the determining is based on whether or not the first network node receives an indication from one of the second network node and a first wireless device comprised in the communications network, wherein the indication indicates whether or not the second network node accepts to serve wireless devices of the first type, and wherein the determining is based on the received indication.

29. The method according to claim 28, wherein at least one of:
the indication is updatable;
one or more third conditions to which the indication is subject are updatable;
the indication is specific to one or more of a cell, a frequency, a tracking area code, a Public Land Mobile Network, and a type of Radio Access Technology;
the indication is based on one or more features supported by a first wireless device of the first type;
the indication is based on the one or more features, the one or more features comprising whether or not the first wireless device supports 1 Receive branch or antenna port or 2 Receive branches or antenna ports;
the indication further indicates one or more cells where the wireless devices of the first type are able to be served or not served;
the indication indicates whether or not the second network node accepts to serve wireless devices of the first type by one of:
its presence; and
a value of the indication;
the wireless devices of the first type are limited in one or more features with respect to wireless devices of a second type;
the wireless devices of the first type are Reduced Capability, RedCap, User Equipments (UEs); and
the first action is at least one of:
refraining from handing over a wireless device of the first type to the second network node;
handing over the wireless device of the first type to the second network node based on one or more second conditions; and
configuring one or more measurements in the wireless device of the first type accordingly.

30. The method according to claim 28, wherein the first network node a first radio access network node, and the second network node is a second radio access network node, and wherein the receiving of the indication is performed according to at least one of:
in an interface between the second network node and the first network node;
when the interface is set up;
in a message received after the interface has been set up;
in one of a Served Cell Information NR IE and a Neighbour Information NR IE;
in a response to a request from the first network node;
with the proviso that the first network node supports wireless devices of the first type;
in a handover request message;
in a response to a message retrieving a UE context;
in a handover procedure; and
during a dual connectivity procedure.

31. The method according to claim 28, further comprising at least one of:
receiving the indication from one of the second network node and the first wireless device;
sending a further indication to the first wireless device or another wireless device, wherein the further indication configures one or more measurements in the first wireless device of the first type according to the received indication; and
receiving a third indication from one of the second network node and the first wireless device or another wireless device, the third indication updating the first indication on whether or not the second network node accepts to serve wireless devices of the first type, and wherein the determining and the performing are repeated based on the received third indication.

32. A method, performed by a second network node, for handling wireless devices, the second network node operating in a communications network, the method comprising:
sending an indication to a first network node comprised in the communications network, the indication indicating whether or not the second network node accepts to serve wireless devices of a first type.

33. The method according to claim 32, wherein at least one of:
the indication is updatable;
one or more third conditions to which the indication is subject are updatable;
the indication is specific to one or more of a cell, a frequency, a tracking area code, a Public Land Mobile Network, and a type of Radio Access Technology;
the indication is based on one or more features supported by a first wireless device of a first type;
the indication is based on the one or more features, the one or more features comprising whether or not the first wireless device supports 1 Receive branch or antenna port or 2 Receive branches or antenna ports;
the indication further indicates one or more cells where the wireless devices of the first type are able to be served or not served;
the indication indicates whether or not the second network node accepts to serve wireless devices of the first type by one of:
its presence; and
a value of the indication;
the wireless devices of the first type are limited in one or more features with respect to wireless devices of a second type; and
the wireless devices of the first type are Reduced Capability, RedCap, User Equipments, UEs.

34. The method according to claim 32, wherein the second network node is a second radio access network node, and the first network node is a first radio access network node, and wherein the sending of the indication is performed according to at least one of:
in an interface between the second network node and the first network node;
when the interface is set up;
in a message sent after the interface has been set up;
in one of a Served Cell Information NR IE and a Neighbour Information NR IE;
in a response to a request from the first network node;
after determining that the first network node supports wireless devices of the first type;
in a handover request message;
in a response to a message retrieving a UE context;
in a handover procedure, wherein the second network node is a source node; and
during a dual connectivity procedure.

35. The method according to claim 32, wherein the sent indication is a first indication, and wherein the method further comprises sending a third indication updating the first indication on whether or not the second network node accepts to serve wireless devices of the first type.

36. The method according to claim 35, wherein the third indication indicates that the second network node no longer accepts to serve wireless devices of the first type, and wherein the method further comprises:
performing a second action based on the second network node no longer accepting to serve wireless devices of the first type, wherein the second action comprises at least one of:
handing over one or more wireless devices of the first type currently served by the second network node to the first network node or another network node operating in the communications network; and
tearing down one or more of respective connections with the one or more wireless devices of the first type currently served by the second network node.

37. A first network node for handling wireless devices, the first network node operating in a communications network and configured to:
determine whether or not a second network node configured to be comprised in the communications network accepts to serve wireless devices of a first type; and
perform a first action based on a result of the determination.

38. The first network node according to claim 37, wherein the first network node is configured to determine whether or not the second network node configured to be comprised in the communications network accepts to serve wireless devices of the first type based on whether or not the first network node receives an indication from one of the second network node and a first wireless device configured to be comprised in the communications network, the indication indicating whether or not the second network node accepts to serve wireless devices of the first type, and on the indication configured to be received.

39. The first network node according to claim 38, wherein at least one of:
the indication is configured to be updatable;
one or more third conditions to which the indication is configured to be subject are configured to be updatable;
the indication is configured to be specific to one or more of a cell, a frequency, a tracking area code, a Public Land Mobile Network, and a type of Radio Access Technology;
the indication is configured to be based on one or more features configured to be supported by a first wireless device of the first type;
the indication is configured to be based on the one or more features, the one or more features being configured to comprise whether or not the first wireless device is configured to support 1 Receive branch or antenna port or 2 Receive branches or antenna ports;
the indication is further configured to indicate one or more cells where the wireless devices of the first type are able to be served or not served;
the indication is configured to indicate whether or not the second network node accepts to serve wireless devices of the first type by one of:
its presence; and
a value of the indication;
the wireless devices of the first type are configured to be limited in one or more features with respect to wireless devices of a second type;
the wireless devices of the first type are configured to be Reduced Capability, RedCap, User Equipments (UEs); and
the first action is configured to be at least one of:
refraining from handing over a wireless device of the first type, to the second network node;
handing over the wireless device of the first type to the second network node based on one or more second conditions; and
configuring one or more measurements in the wireless device of the first type accordingly.

40. The first network node according to claim 38, wherein the first network node is configured to be a first radio access network node, and the second network node is configured to be a second radio access network node, and wherein the receiving of the indication is configured to be performed according to at least one of:
in an interface between the second network node and the first network node;
when the interface is configured to be set up;
in a message configured to be received after the interface is configured to have been set up;
in one of a Served Cell Information NR IE and a Neighbour Information NR IE;
in a response to a request from the first network node;
with the proviso that the first network node is configured to support wireless devices of the first type;
in a handover request message;
in a response to a message configured to retrieve a UE context;
in a handover procedure; and
during a dual connectivity procedure.

41. The first network node according to claim 38, further configured to at least one of:
receive the indication from one of the second network node and the first wireless device;
send a further indication to the first wireless device or another wireless device, wherein the further indication is configured to configure one or more measurements in the first wireless device of the first type according to the indication configured to be received; and
receive a third indication from one of the second network node and the first wireless device or another wireless device, the third indication being configured to update the first indication on whether or not the second network node is configured to accept to serve wireless devices of the first type, and wherein the determining and the performing are configured to be repeated based on the third indication configured to be received.

42. A second network node for handling wireless devices, the second network node operating in a communications network and configured to:
send an indication to a first network node configured to be comprised in the communications network, the indication indicating whether or not the second network node accepts to serve wireless devices of a first type.

43. The second network node according to claim 42, wherein at least one of:
the indication is configured to be updatable;
one or more third conditions to which the indication is configured to be subject are configured to be updatable;
the indication is configured to be specific to one or more of a cell, a frequency, a tracking area code, a Public Land Mobile Network, and a type of Radio Access Technology;
the indication is configured to be based on one or more features configured to be supported by a first wireless device of a first type;
the indication is configured to be based on the one or more features, the one or more features comprising whether or not the first wireless device supports 1 Receive branch or antenna port or 2 Receive branches or antenna ports;
the indication is configured to further indicate one or more cells where the wireless devices of the first type are able to be served or not served;
the indication is configured to indicate whether or not the second network node accepts to serve wireless devices of the first type by one of:
its presence; and
a value of the indication,
the wireless devices of the first type are configured to be limited in one or more features with respect to wireless devices of a second type; and
the wireless devices of the first type are configured to be Reduced Capability, RedCap, User Equipments (UEs).

44. The second network node according to claim 42, wherein the second network node is configured to be a second radio access network node, and the first network node is configured to be a first radio access network node, and wherein the second network node is configured to send the indication according to at least one of:
in an interface between the second network node and the first network node;
when the interface is configured to be set up;
in a message configured to be sent after the interface is configured to have been set up;
in one of a Served Cell Information NR IE and a Neighbour Information NR IE;
in a response to a request from the first network node;
after determining that the first network node is configured to support wireless devices of the first type;
in a handover request message;
in a response to a message configured to retrieve a UE context;
in a handover procedure, wherein the second network node is configured to be a source node; and
during a dual connectivity procedure.

45. The second network node according to claim 42, wherein the indication configured to be sent is a first indication, and wherein the second network node is further configured to:
send a third indication configured to update the first indication on whether or not the second network node is configured to accept to serve wireless devices of the first type.

46. The second network node according to claim 45, wherein the third indication indicates that the second network node no longer accepts to serve wireless devices of the first type, and wherein the second network node is further configured to:
perform a second action based on the second network node no longer accepting to serve wireless devices of the first type, wherein the second action is configured to comprise at least one of:
handing over one or more wireless devices of the first type configured to be currently served by the second network node to the first network node or another network node configured to be operating in the communications network; and
tearing down one or more of respective connections with the one or more wireless devices of the first type configured to be currently served by the second network node.
